(19) United States
(12) Patent Application Publication
(10) Pub. No.: US 2026/0129109 A1
(43) Pub. Date: May 7, 2026

(54) Packet Transmission Method and Apparatus, Storage Medium, Device, and System

(71) Applicant: Tencent Technology (Shenzhen) Company Limited, Shenzhen (CN)

(72) Inventor: Kailang DENG, Shenzhen (CN)

(73) Assignee: Tencent Technology (Shenzhen) Company Limited, Shenzhen (CN)

(21) Appl. No.: 19/437,974

(22) Filed: Dec. 31, 2025

Related U.S. Application Data
(63) Continuation of application No. PCT/CN2024/123841, filed on Oct. 10, 2024.

(30) Foreign Application Priority Data
Oct. 11, 2023 (CN) 202311314302.1

(51) Int. Cl. H04L 69/22

(52) U.S. Cl. CPC H04L 69/22

(57) ABSTRACT

Embodiments of the present disclosure disclose a packet transmission method and apparatus, a storage medium, a device, and a system. The method includes: obtaining a first jumbo frame packet, the first jumbo frame packet carrying a jumbo frame identifier; transmitting the first jumbo frame packet to a second server through a first transmission tunnel; determining a probe result for the first transmission tunnel based on a time relationship between transmitting time of the first jumbo frame packet and receiving time of a reply packet when receiving the reply packet returned by the second server based on the jumbo frame identifier in the first jumbo frame packet; and obtaining a second jumbo frame packet and transmitting the second jumbo frame packet to the second server through the first transmission tunnel when the probe result indicates that the first transmission tunnel is suitable for jumbo frame transmission.

### RELATED APPLICATION

The present disclosure is a continuation of and claims the benefit of priority to PCT Application No. PCT/CN2024/123841, filed Oct. 10, 2024, and entitled MESSAGE TRANSMISSION METHOD, APPARATUS AND SYSTEM, AND STORAGE MEDIUM AND DEVICE, which is based on and claims the benefit of priority to Chinese Patent Application No. 2023113143021, filed with the China National Intellectual Property Administration on Oct. 11, 2023 and entitled “PACKET TRANSMISSION METHOD AND APPARATUS, STORAGE MEDIUM, DEVICE, AND SYSTEM.” The above applications are incorporated herein by reference in their entireties.

### FIELD OF THE TECHNOLOGY

The present disclosure relates to the field of network technologies, and specifically, to a packet transmission method and apparatus, a storage medium, a device, and a system.

### BACKGROUND OF THE DISCLOSURE

Currently, with development of internet technologies, to satisfy data transmission requirements, increasingly large Ethernet frame packets need to be transmitted between networks. Therefore, more networks start to perform data transmission by using jumbo frame (also referred to as giant frame) packets.

In a related technology, not all tunnels between networks support forwarding of a jumbo frame packet. If an intermediate network device on a tunnel between the networks does not support forwarding of the jumbo frame packet, the intermediate network device returns a piece of error information to the network. After receiving the error information, the network may confirm that the corresponding tunnel does not support forwarding of the jumbo frame packet.

However, if the intermediate network device needs to return the error information, a processor of the intermediate network device needs to process and analyze each received data packet. As a result, load of the processor of the intermediate network device is excessively high, and performance and a response speed of the intermediate network device are affected. Consequently, it is difficult for the networks to detect whether the tunnel supports forwarding of the jumbo frame packet, causing a transmission failure of the jumbo frame packet, and reducing efficiency of packet transmission between the networks.

### SUMMARY

Embodiments of the present disclosure provide a packet transmission method and apparatus, a storage medium, a device, and a system, to improve packet transmission efficiency.

To resolve the foregoing technical problem, the embodiments of the present disclosure provide the following technical solutions.

A packet transmission method, performed by a first server, the method including:
obtaining a first jumbo frame packet, the first jumbo frame packet carrying a jumbo frame identifier;
transmitting the first jumbo frame packet to a second server through a first transmission tunnel, the first transmission tunnel being one of at least one transmission tunnel for communicating with the second server;
determining a probe result for the first transmission tunnel based on a time relationship between transmitting time of the first jumbo frame packet and receiving time of a reply packet when receiving the reply packet returned by the second server based on the jumbo frame identifier in the first jumbo frame packet; and
obtaining a second jumbo frame packet and transmitting the second jumbo frame packet to the second server through the first transmission tunnel when the probe result indicates that the first transmission tunnel is suitable for jumbo frame transmission.

A packet transmission method, performed by a second server, the method including:
receiving, through a first transmission tunnel, a first jumbo frame packet transmitted by a first server, the first jumbo frame packet carrying a jumbo frame identifier, and the first transmission tunnel being one of at least one transmission tunnel for communicating with the first server;
generating a reply packet based on the jumbo frame identifier in the first jumbo frame packet;
transmitting the reply packet to the first server through the first transmission tunnel, so that the first server determines a probe result for the first transmission tunnel based on a time relationship between transmitting time of the first jumbo frame packet and receiving time of the reply packet; and
receiving, through the first transmission tunnel, a second jumbo frame packet transmitted by the first server, the second jumbo frame packet being transmitted by the first server when the probe result indicates that the first transmission tunnel is suitable for jumbo frame transmission.

A packet transmission apparatus, including:
a packet obtaining unit, configured to obtain a first jumbo frame packet, the first jumbo frame packet carrying a jumbo frame identifier;
a packet probe unit, configured to transmit the first jumbo frame packet to a second server through a first transmission tunnel, the first transmission tunnel being one of at least one transmission tunnel for communicating with the second server;
a result determining unit, configured to determine a probe result for the first transmission tunnel based on a time relationship between transmitting time of the first jumbo frame packet and receiving time of a reply packet when receiving the reply packet returned by the second server based on the jumbo frame identifier in the first jumbo frame packet; and
a packet transmission unit, configured to obtain a second jumbo frame packet and transmit the second jumbo frame packet to the second server through the first transmission tunnel when the probe result indicates that the first transmission tunnel is suitable for jumbo frame transmission. A computer-readable storage medium, having a plurality of instructions stored therein, the instructions being suitable for being loaded by a processor to perform the operations in the foregoing packet transmission method.

A computer device, including a memory, a processor, and a computer program that is stored in the memory and that is executable on the processor, the processor, when executing the computer program, implementing the operations in the foregoing packet transmission method.

A packet transmission system, the system including a first server and a second server;
the first server including the foregoing packet transmission apparatus; and
the second server including the foregoing packet transmission apparatus.

A computer program product or a computer program, the computer program product or the computer program including computer instructions, and the computer instructions being stored in a storage medium. A processor of a computer device reads the computer instructions from the storage medium, and the processor executes the computer instructions, causing the operations in the foregoing packet transmission method to be implemented.

### BRIEF DESCRIPTION OF THE DRAWINGS

To describe technical solutions in embodiments of the present disclosure more clearly, the following briefly describes the accompanying drawings for describing the embodiments. It is clear that the accompanying drawings in the following descriptions show merely some embodiments of the present disclosure, and a person skilled in the art may still derive other drawings from these accompanying drawings without creative efforts.

FIG. 1 is an example schematic diagram of a scenario of packet transmission in a related technology according to an embodiment of the present disclosure;

FIG. 2 is an example schematic diagram of a scenario of a packet transmission system according to an embodiment of the present disclosure;

FIG. 3 is an example schematic flowchart of a packet transmission method according to an embodiment of the present disclosure;

FIG. 4 is an example schematic diagram of a packet transmission process between a first server and a second server according to an embodiment of the present disclosure;

FIG. 5 is an example schematic diagram of a scenario in which a first server cannot receive a reply packet in a timely manner due to network congestion according to an embodiment of the present disclosure;

FIG. 6 is an example schematic diagram of a scenario in which a first jumbo frame packet cannot be forwarded through a first transmission tunnel according to an embodiment of the present disclosure;

FIG. 7 is another example schematic flowchart of a packet transmission method according to an embodiment of the present disclosure;

FIG. 8 is an example schematic diagram of interaction of a packet transmission system according to an embodiment of the present disclosure;

FIG. 9 is an example complete schematic flowchart of a packet transmission method according to an embodiment of the present disclosure;

FIG. 10 is an example schematic flowchart of a packet transmission method performed by a first server according to an embodiment of the present disclosure;

FIG. 11 is an example schematic flowchart of a packet transmission method performed by a second server according to an embodiment of the present disclosure;

FIG. 12 is an example schematic structural diagram of a packet transmission apparatus according to an embodiment of the present disclosure;

FIG. 13 is another example schematic structural diagram of a packet transmission apparatus according to an embodiment of the present disclosure; and

FIG. 14 is an example schematic structural diagram of a terminal according to an embodiment of the present disclosure.

### DESCRIPTION OF EMBODIMENTS

To make solutions of the present disclosure more comprehensible for a person skilled in the art, the following clearly and completely describes the technical solutions in embodiments of the present disclosure with reference to the accompanying drawings in the embodiments of the present disclosure. It is clear that the described embodiments are merely some rather than all of the embodiments of the present disclosure. Based on the embodiments of the present disclosure, all other embodiments obtained by a person skilled in the art without creative efforts fall within the protection scope of the present disclosure.

In a specific implementation of the present disclosure, relevant data such as the file data involved, when the foregoing embodiments of the present disclosure are applied to a specific product or technology, needs to obtain the user's permission or consent. In addition, the acquisition, use, and processing of relevant data need to comply with relevant laws, regulations, and standards of relevant countries and regions.

In a specific implementation of the present disclosure, relevant data such as the subscriber data involved, when the foregoing embodiments of the present disclosure are applied to a specific product or technology, needs to obtain the subscriber's permission or consent. In addition, the acquisition, use, and processing of relevant data need to comply with relevant laws, regulations, and standards.

In addition, when relevant data such as the subscriber data is needed in the embodiments of the present disclosure, individual permission or individual consent of the relevant data such as the subscriber data is obtained through a pop-up window, jumping to a confirmation page, or the like. After the individual permission or the individual consent of the relevant data such as the subscriber data is explicitly obtained, necessary relevant data such as the subscriber data for enabling the embodiments of the present disclosure to operate normally is obtained.

In some processes described in the specification, the claims, and the foregoing accompanying drawings, a plurality of operations occurring in a specific sequence are included. However, these operations may not be performed in the sequence in which the operations occur in this specification or performed in parallel. The sequence numbers of the operations are merely for distinguishing different operations, and do not indicate any execution sequence. In addition, descriptions such as “first”, “second”, “target”, or the like in this specification are intended to distinguish similar objects rather than describing a specific sequence or chronological order.

Before the embodiments of the present disclosure are further described in detail, the nouns and terms involved in the embodiments of the present disclosure are described. The nouns and terms involved in the embodiments of the present disclosure are suitable to explain as follows:

A jumbo frame is also referred to as a large frame or a giant frame, and refers to an Ethernet frame whose payload exceeds 1500 bytes limited by the IEEE 802.3 standard. Usually, the jumbo frame can carry a payload of a maximum of 9000 bytes. The jumbo frame is an ultra-long frame format in a vendor standard and is specifically designed for a gigabit Ethernet. The jumbo frame has different lengths. The jumbo frame can make full use of performance of the gigabit Ethernet and improve data transmission efficiency. Therefore, in an application environment of network storage, the jumbo frame has more unusual significance.

The Internet Control Message Protocol (ICMP) is an error report mechanism, is an important sub-protocol in a TCP/IP protocol cluster, is usually used by an IP layer or a higher layer protocol (TCP or UDP), is a network layer protocol, is mainly configured for transferring control messages between an IP host and a router, and is configured for reporting whether the host is reachable, whether routing is available, and the like. Although user data is not transmitted in these control messages, the control messages play a vital role in collecting various types of network information, diagnosing and removing various network faults, and transferring the user data.

A maximum transmission unit (MTU) refers to a maximum size of a data packet that can be transmitted by a network, and is measured in bytes. The size of the MTU determines a maximum quantity of bytes of a packet that can be transmitted by a transmitter at a time. If the MTU exceeds a maximum value that can be borne by a receiver, or exceeds a maximum value that can be borne by a device on a transmission path, packet fragmentation or even discarding may be caused, increasing a burden of network transmission. If the size is excessively small, a volume of actually transmitted data is excessively small, affecting transmission efficiency.

A tunnel is also referred to as a channel, may represent a transmission tunnel (which may also be referred to as a connection tunnel) from a network to another network, is a technology in which a network protocol is encapsulated in another network protocol for transmission, and allows a data packet of a network to be transmitted in another network, so that networks that are incompatible or cannot directly communicate with each other originally can communicate with each other. According to the tunnel technology, when a data packet is transmitted from a source end to a destination end, the data packet is first encapsulated in a new protocol header, then transmitted in a network, and finally decapsulated at the destination end, to restore the original data packet. There may be a plurality of tunnels between networks, and each tunnel may be configured with different MTU sizes.

A server is a machine that provides information for a person to access. A server part is information and functions shared by a plurality of objects, and performs background services. Through configuration of appropriate network software and settings, the server may be configured to act as a gateway, and may receive data packets from a local network, and route these data packets to another network based on a destination address. Such a configuration enables the server to connect to different networks and provide functions such as routing, forwarding, and network address translation (NAT). A first server and a second server may be included in the embodiments of the present disclosure.

A region refers to a specific geographical region or data center, and is configured for hosting and providing a cloud service. A region usually includes one or more data centers. These data centers have a relatively short physical distance and are usually located in the same geographical region. Each data center has an independent computing resource, storage device, and network facility, and can provide various cloud services, such as a virtual machine instance, storage, a network, and a database. Different regions may be communicatively connected to each other.

A network service header (NSH) is a network protocol header, and is configured for defining and managing a service function chain in a network. The network service header is an open standard defined by the Internet Engineering Task Force. The NSH may be designed to orchestrate various network services performed on a network path, such as a firewall, a load balancer, an encryptor, and a decryptor, and connect network service functions in series to form an ordered service chain. These service functions can be sequentially accessed according to a specified sequence during data packet transmission.

In some embodiments, if jumbo frame capability detection needs to be performed between networks, a cache MTU configuration needs to be stored for each network tunnel. When a jumbo frame packet is forwarded, if an intermediate network device on a transmission tunnel does not support forwarding of a jumbo frame, the intermediate network device returns a piece of error information, for example, an ICMPv4 Destination Unreachable/ICMPv6 Packet Too Big error Message, which carries a maximum MTU supported by the intermediate network device. A local end updates a cache MTU of the corresponding tunnel.

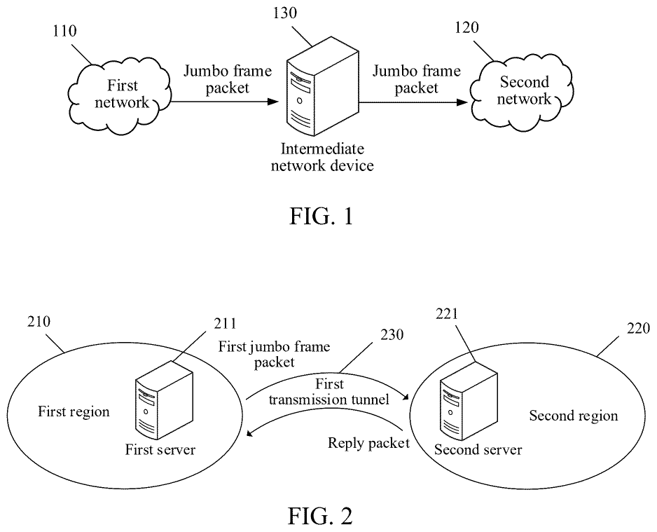

Referring to FIG. 1, FIG. 1 is a schematic diagram of a scenario of packet transmission in a related technology according to an embodiment of the present disclosure. If a first network 110 needs to forward a jumbo frame packet to a second network 120, the first network 110 needs to transmit the jumbo frame packet to an intermediate network device 130 on a tunnel. If the intermediate network device 130 does not support forwarding of a jumbo frame, the intermediate network device 130 returns a piece of error information to the first network 110, which carries a maximum MTU supported by the intermediate network device 130. After receiving the error information, the first network 110 may determine an actual MTU of the tunnel.

However, the related technology relies on the intermediate network device returning the error information. When the intermediate network device enables an error message reply function, the intermediate network device needs to process and analyze each received data packet, to determine whether a corresponding error message reply needs to be transmitted. This processing process is usually completed by a central processing unit (CPU) of the device. If the intermediate network device frequently receives a large quantity of data packets and needs to return error messages, an attacker may use this point to perform a denial of service (DoS) attack, to transmit a large quantity of forged data packets or particular malicious data packets to the intermediate network device, triggering the device to transmit a large quantity of error message replies. In this case, the CPU of the intermediate network device is occupied to process these error message replies. As a result, load of the CPU is increased, and the intermediate network device cannot normally process other normal network traffic. Consequently, the intermediate network device is easily attacked, affecting performance and a response speed of the device.

Therefore, to prevent the intermediate network device from easily becoming an attack target due to high load of the CPU, many intermediate network devices disable the error message reply function by default. Finally, it is difficult for networks to detect whether a tunnel supports forwarding of a jumbo frame packet, causing a transmission failure of the jumbo frame packet, and reducing efficiency of packet transmission between the networks.

To resolve the foregoing problem, the embodiments of the present disclosure provide a packet transmission method and apparatus, a storage medium, a device, and a system, to improve packet transmission efficiency.

Referring to FIG. 2, FIG. 2 is a schematic diagram of a scenario of a packet transmission system according to an embodiment of the present disclosure, including a first server 211 deployed in a first region 210 and a second server 221 deployed in a second region 220. The first server 211 may route, to a corresponding tunnel (for example, a first transmission tunnel 230), a packet that needs to be transmitted in the first region 211, to transmit the packet to the second server 221. The second server 221 may also route, to a corresponding tunnel, a packet that needs to be transmitted in the second region 221, to transmit the packet to the first server 211.

The packet transmission method in the embodiments of the present disclosure is to implement communication between two networks in the first region 210 and the second region 220. In this embodiment of the present disclosure, the first server 211 is a server deployed at the edge of the first region 210, and integrates a gateway function. In other words, a gateway device or an external gateway device (not identified) is deployed on the first server 211. The gateway device implements a role for data exchange and routing in a network, and is responsible for functions such as data forwarding, filtering, and routing. Therefore, the first server 211 can transmit the packet to the second server 221. Similarly, the second server 221 is a server deployed at the edge of the second region 220, and integrates a gateway function. In other words, a gateway device or an external gateway device (not identified) is deployed on the second server 221. The gateway device implements a role for data exchange and routing in a network, and is responsible for functions such as data forwarding, filtering, and routing. Therefore, the second server 221 can return the packet to the first server 211.

The packet transmission system may include a packet transmission apparatus. The packet transmission apparatus may be specifically integrated into the first server 211. The first server 211 may include, but is not limited to, a mobile phone, a computer, an intelligent voice interaction device, an intelligent appliance, an in-vehicle terminal, an aircraft, or the like. However, this is not limited. The first server may alternatively be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a CDN, and a big data and artificial intelligence platform. As shown in FIG. 2, the first server 211 may obtain a first jumbo frame packet, the first jumbo frame packet carrying a jumbo frame identifier; transmit the first jumbo frame packet to the second server 221 through the first transmission tunnel 230, the first transmission tunnel 230 being one of at least one transmission tunnel for communicating with the second server 221; when receiving a reply packet returned by the second server 221 based on the jumbo frame identifier in the first jumbo frame packet, determine a probe result for the first transmission tunnel 230 based on a time relationship between transmitting time of the first jumbo frame packet and receiving time of the reply packet; and when the probe result indicates that the first transmission tunnel 230 is suitable for jumbo frame transmission, obtain a second jumbo frame packet, and transmit the second jumbo frame packet to the second server 221 through the first transmission tunnel 230.

The packet transmission apparatus may be alternatively specifically integrated into the second server 221. The second server 221 may include, but is not limited to, a mobile phone, a computer, an intelligent voice interaction device, an intelligent appliance, an in-vehicle terminal, an aircraft, or the like. However, this is not limited. The second server may alternatively be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a CDN, and a big data and artificial intelligence platform. As shown in FIG. 2, the second server 221 may receive, through the first transmission tunnel 230, a first jumbo frame packet transmitted by the first server, the first jumbo frame packet carrying a jumbo frame identifier, and the first transmission tunnel being one of at least one transmission tunnel for communicating with the first server; generate a reply packet based on the jumbo frame identifier in the first jumbo frame packet; transmit the reply packet to the first server through the first transmission tunnel, so that the first server determines a probe result for the first transmission tunnel based on a time relationship between transmitting time of the first jumbo frame packet and receiving time of the reply packet; and receive, through the first transmission tunnel, a second jumbo frame packet transmitted by the first server, the second jumbo frame packet being transmitted by the first server when the probe result indicates that the first transmission tunnel is suitable for jumbo frame transmission.

The schematic diagram of the scenario of the packet transmission system shown in FIG. 2 is merely an example. The packet transmission system and the scenario described in this embodiment of the present disclosure are intended to describe the technical solutions in the embodiments of the present disclosure more clearly and do not constitute a limitation to the technical solutions provided in the embodiments of the present disclosure. A person of ordinary skill in the art may know that, with the evolution of the packet transmission system and the emergence of new service scenarios, the technical solutions provided in the embodiments of the present disclosure are also applicable to similar technical problems.

In this embodiment, descriptions are provided from the perspective of the packet transmission apparatus. The packet transmission apparatus may be specifically integrated into a server that has a storage unit and in which a microprocessor is installed to have a computing capability, including the first server and the second server.

This embodiment of the present disclosure may be applied to various scenarios, including, but not limited to, a cloud technology, artificial intelligence, smart transportation, assisted driving, and the like.

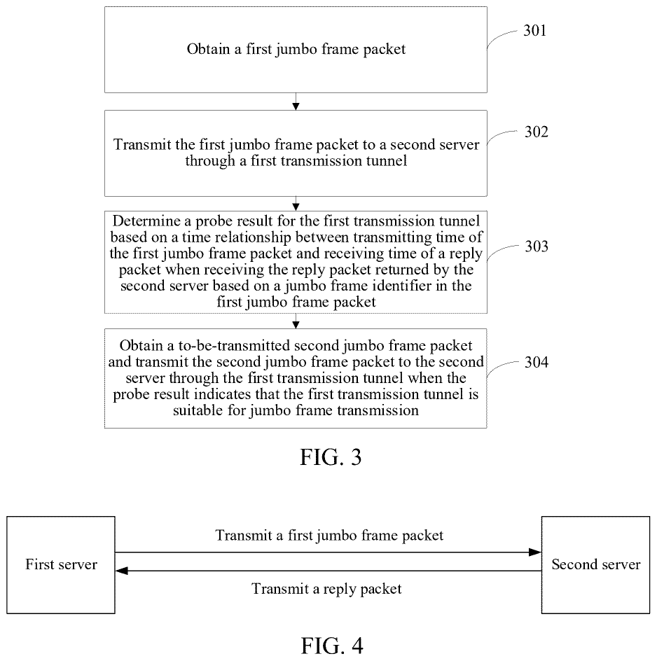

Referring to FIG. 3, FIG. 3 is a schematic flowchart of a packet transmission method according to an embodiment of the present disclosure. The packet transmission method may be applied to the first server in the foregoing embodiment, or the first region in which the first server is located. The packet transmission method includes the following operations.

Operation 301: Obtain a first jumbo frame packet.

The first jumbo frame packet carries a jumbo frame identifier.

The first jumbo frame packet is a jumbo frame packet, and the jumbo frame packet refers to an Ethernet frame packet whose length is greater than or equal to 1500 bytes. The first jumbo frame packet is configured for probing a first transmission tunnel. Herein, the probing refers to probing a transmission tunnel between networks. Therefore, the first jumbo frame packet is an Ethernet frame packet configured for probing whether the transmission tunnel between the networks is suitable for jumbo frame transmission.

The jumbo frame identifier is identification information carried in the first jumbo frame packet, is additional information carried in the packet, and is configured for identifying the packet as a jumbo frame packet. After receiving the first jumbo frame packet, another network or server may identify the jumbo frame identifier from the first jumbo frame packet, to determine that the received packet is a jumbo frame packet, and further perform feedback based on the jumbo frame identifier.

In addition to the jumbo frame identifier, the first jumbo frame packet may further carry other information to satisfy a particular requirement. For example, the first jumbo frame packet may further carry test data. The data may be randomly generated data having a particular pattern, or a predefined test case. In addition, to ensure integrity and accuracy of the packet, the first jumbo frame packet may further carry a checksum field, so that an end receiving the first jumbo frame packet can verify integrity of the packet by calculating a checksum, and perform error detection. In this embodiment of the present disclosure, the other information carried in the first jumbo frame packet is not specifically limited.

For example, there are a plurality of manners of obtaining the first jumbo frame packet. For example, a jumbo frame packet of a specified size may be constructed on the first server, and a jumbo frame identifier is set. In this manner, the first server needs to have a capability of constructing and transmitting a customized packet. Alternatively, an existing packet may be intercepted on the first server, then a size of the packet is modified to be a size of a jumbo frame, and a jumbo frame identifier is added. In this manner, the first server needs to have a capability of intercepting and modifying network traffic. In addition, the first jumbo frame packet may be alternatively obtained from a preset packet database. The database stores a plurality of jumbo frame packets of different sizes, to facilitate probing of jumbo frame forwarding capabilities for different transmission tunnels.

In conclusion, in this embodiment, the first jumbo frame packet carrying the jumbo frame identifier is obtained, so that it can be convenient to subsequently probe, based on the first jumbo frame packet, whether a transmission tunnel is suitable for forwarding a jumbo frame. Because the first jumbo frame packet carries the jumbo frame identifier, a peer device that subsequently receives the first jumbo frame packet may reply based on the packet, so that the first server may determine, based on a reply status, whether the transmission tunnel is suitable for jumbo frame transmission.

A specific process of obtaining the first jumbo frame packet in operation 301 is described in detail below.

In some implementations, the first jumbo frame packet is obtained by adding a jumbo frame identifier to header information of an initial jumbo frame packet, including:

(1) Obtain the initial jumbo frame packet, and extract the header information of the initial jumbo frame packet.

(2) Generate the jumbo frame identifier for the initial jumbo frame packet, and add the jumbo frame identifier to the header information of the initial jumbo frame packet, to obtain the first jumbo frame packet.

The initial jumbo frame packet is a jumbo frame packet, and also refers to an Ethernet frame packet whose length is greater than or equal to 1500 bytes. The initial means that the jumbo frame identifier has not been added to the packet. Therefore, the initial jumbo frame packet is a jumbo frame packet obtained at an early stage. An Ethernet frame packet configured for probing whether a transmission tunnel between networks is suitable for jumbo frame transmission can be obtained only after the jumbo frame identifier is added.

The header information of the initial jumbo frame packet refers to a group of fields or data located in a former part in the packet, that is, a header of the packet, is configured for describing metadata and control information of the packet, and includes parameters and attributes related to packet transmission, parsing, and processing. Extracting the header information of the initial jumbo frame packet may be performed according to a specific transport protocol and packet format. This is not specifically limited herein.

In this embodiment, after the initial jumbo frame packet is obtained, the jumbo frame identifier may be generated for the initial jumbo frame packet. Specifically, a format of the jumbo frame identifier may be first determined, a data format and a length of the jumbo frame identifier are determined, and a binary string with a particular length or a particular flag symbol is selected as the jumbo frame identifier. In addition, a value of the jumbo frame identifier may be further generated according to a system design and requirement. This may be implemented by using various algorithms, a random number generator, or a particular coding rule. Subsequently, the jumbo frame identifier is added to the header information of the initial jumbo frame packet, to obtain the first jumbo frame packet.

For example, after the header information of the initial jumbo frame packet is extracted, in this embodiment of the present disclosure, a network service header jumbo frame identifier (Network Service Header Jumbo-Ping) may be added to the header information of the initial jumbo frame packet, which may also be written as NSH Jumbo-Ping, and may also be used as a Ping request and identify that the current packet is a jumbo frame packet. A packet obtained after the header information is modified is the first jumbo frame packet.

In conclusion, in this embodiment, to probe whether a transmission tunnel is suitable for jumbo frame transmission, the initial jumbo frame packet needs to be obtained, and the jumbo frame identifier needs to be added to the header information of the initial jumbo frame packet, to obtain the first jumbo frame packet. Compared with the initial jumbo frame packet, the first jumbo frame packet has an extra jumbo frame identifier field, which is configured for verifying a support status of a transmission tunnel for jumbo frame transmission. In addition, in this embodiment of the present disclosure, adding the jumbo frame identifier only by modifying the header information of the packet is an in-band probe method, which can reduce bandwidth costs of jumbo frame probe, does not need to additionally add other information, and does not significantly change data. Therefore, modification costs are low, and probe efficiency is high.

In some implementations, to obtain the first jumbo frame packet, this embodiment of the present disclosure may further include:

(1) Determine a packet length value of the initial jumbo frame packet.

(2) Obtain a transmission limit value of the first transmission tunnel from a preset configuration table.

The configuration table includes transmission limit values of a plurality of transmission tunnels.

(3) Fragment the initial jumbo frame packet based on the transmission limit value when the packet length value of the initial jumbo frame packet is greater than the transmission limit value of the first transmission tunnel, to obtain an initial jumbo frame packet whose packet length value does not exceed the transmission limit value.

The packet length value refers to length information of the initial jumbo frame packet, that is, a quantity of bytes of data or a payload included in the packet. In network communication, each packet has a particular length value configured for indicating a size of the packet. The packet length value may be extracted from the initial jumbo frame packet according to an actual situation.

For example, the length information of the packet is included in a packet header or a specific field, and a specific location and format may depend on a used protocol or data format. For example, in the Ethernet, the packet length may usually be obtained by using a length field in an Ethernet frame header. In other protocols or applications, the packet length may be indicated in different manners. This is not specifically limited in this embodiment of the present disclosure.

In this embodiment, the actual length information of the packet can be obtained by extracting the packet length value of the initial jumbo frame packet. The length value is compared with the transmission limit value of the first transmission tunnel, to determine whether the initial jumbo frame packet needs to be fragmented to generate the first jumbo frame packet.

The configuration table is a storage table preset by the first server, and may store information related to each transmission tunnel, including storing the transmission limit values of the plurality of transmission tunnels. After the first transmission tunnel that currently needs to be probed is determined, the transmission limit value of the first transmission tunnel may be obtained from the configuration table.

In addition to the transmission limit value of each transmission tunnel, the configuration table may further carry other information to satisfy particular requirements. For example, a unique identifier of each packet forwarded on the transmission tunnel may be carried, and the unique identifier may be an identity of the packet. Timestamps of transmitting and receiving each packet forwarded on the transmission tunnel may be further carried. An identifier of a device to which each packet is transmitted on the transmission tunnel may be further carried. Content stored in the configuration table is not specifically limited in this embodiment of the present disclosure.

The transmission limit value is an MTU value, and is configured for limiting a size of a longest packet that can be transmitted through a corresponding transmission tunnel. However, in this embodiment of the present disclosure, the transmission limit value is not necessarily an MTU value of transmission that is actually supported by the transmission tunnel. The transmission limit value is added to the configuration table after pre-description. In other words, the transmission limit value is recorded in the configuration table to describe a maximum MTU value of transmission that can be supported by the transmission tunnel.

In this embodiment, due to existence of the transmission limit value, if the packet length value of the initial jumbo frame packet is less than or equal to the transmission limit value of the first transmission tunnel, it indicates that the initial jumbo frame packet can be forwarded through the transmission tunnel according to the pre-description. However, if the packet length value of the initial jumbo frame packet is greater than the transmission limit value of the first transmission tunnel, it indicates that the length of the initial jumbo frame packet exceeds a transmission limit of the transmission tunnel according to the pre-description. Therefore, fragmentation processing needs to be performed on the initial jumbo frame packet, and after the initial jumbo frame packet is fragmented based on the transmission limit value, the first jumbo frame packet can be obtained.

There may be a plurality of first jumbo frame packets obtained after fragmentation. However, in this embodiment of the present disclosure, a longest packet obtained after fragmentation is determined as the first jumbo frame packet. For example, the original packet length value of the initial jumbo frame packet is 9000 bytes, but the transmission limit value of the first transmission tunnel is 8000 bytes. In this case, after the initial jumbo frame packet is fragmented according to the 8000 bytes, one 8000-byte packet and one 1000-byte packet can be obtained. Finally, the 8000-byte packet obtained after fragmentation is determined as an initial jumbo frame packet whose packet length value does not exceed the transmission limit value, that is, an initial jumbo frame packet obtained after fragmentation is determined. In other words, fragmentation is to reduce a data volume of an initial jumbo frame packet by segmenting data of the initial jumbo frame packet, to modify a packet length to be consistent with the transmission limit value. A length value of the initial jumbo frame packet obtained after fragmentation is the same as the transmission limit value of the first transmission tunnel. Further, the first jumbo frame packet may be obtained by using the initial jumbo frame packet obtained after fragmentation.

In conclusion, in this embodiment, an objective of obtaining the first jumbo frame packet by using the initial jumbo frame packet obtained after fragmentation is to adapt to the transmission limit value of the first transmission tunnel, to ensure that the first jumbo frame packet can be normally transmitted on the first transmission tunnel. In network communication, different transmission tunnels may strictly limit a size of a data packet, which is also referred to as a transmission limit value. If a size of an initial jumbo frame packet to be transmitted exceeds the transmission limit value of the first transmission tunnel, the entire jumbo frame packet cannot be transmitted on the first transmission tunnel, and naturally probe cannot be performed. Therefore, fragmentation processing needs to be performed on the initial jumbo frame packet that exceeds the transmission limit value, to ensure that subsequent probe on a forwarding capability of the first transmission tunnel is successfully performed.

Operation 302: Transmit the first jumbo frame packet to a second server through the first transmission tunnel.

The first transmission tunnel is one of at least one transmission tunnel for communicating with the second server.

At least one transmission tunnel may be provided between the first server and the second server, and each transmission tunnel may include a different network path or link. In this embodiment of the present disclosure, whether each of the plurality of transmission tunnels is suitable for jumbo frame packet transmission may be probed, and the first transmission tunnel is one of the at least one transmission tunnel. To be specific, the first transmission tunnel is a transmission tunnel selected for current probe in the at least one transmission tunnel.

For example, when there are a plurality of transmission tunnels, there are a plurality of manners of selecting the first transmission tunnel. For example, in this embodiment of the present disclosure, one of the transmission tunnels may be randomly selected as the first transmission tunnel. Alternatively, one of the transmission tunnels may be sequentially selected as the first transmission tunnel according to a sequence of the transmission tunnels. Alternatively, a transmission tunnel may be sequentially selected as the first transmission tunnel in descending order or in ascending order according to a size arrangement sequence between the transmission tunnels. Alternatively, routing may be performed on the plurality of transmission tunnels, to select a transmission tunnel as the first transmission tunnel based on a routing result.

Routing the plurality of transmission tunnels is used as an example for description. In this embodiment of the present disclosure, an objective of routing is to select, based on a network topology and a condition, an optimal transmission tunnel for packet forwarding. In a routing process, a routing table is first queried. The routing table is a data structure that stores a mapping relationship between a network destination and a next hop. Based on a destination address of a packet, a routing item that best matches the destination address may be found from the routing table, to determine the first transmission tunnel to the second server to which the packet needs to be transmitted. Therefore, the first transmission tunnel is selected through routing, so that optimal packet transmission can be implemented, and load balance, fault tolerance, and reliability of a network can be improved.

In conclusion, in this embodiment, the first jumbo frame packet is transmitted to the second server through the first transmission tunnel, and whether the first transmission tunnel is suitable for jumbo frame transmission can be detected. Subsequently, the first server may determine, based on whether the second server returns a packet or a status of returning a packet, whether the first transmission tunnel is suitable for jumbo frame transmission.

Referring to FIG. 4, FIG. 4 is a schematic diagram of a packet transmission process between a first server and a second server according to an embodiment of the present disclosure. It can be learned from FIG. 4 that after the first server transmits the first jumbo frame packet to the second server through the first transmission tunnel, if the first transmission tunnel supports jumbo frame forwarding, after receiving the first jumbo frame packet, the second server transmits a reply packet to the first server. The following describes a working procedure after the reply packet is received.

Operation 303: Determine a probe result for the first transmission tunnel based on a time relationship between transmitting time of the first jumbo frame packet and receiving time of the reply packet when receiving the reply packet returned by the second server based on the jumbo frame identifier in the first jumbo frame packet.

After receiving the first jumbo frame packet, the second server may normally forward the first jumbo frame packet to another device in a network in which the second server is located. After receiving the first jumbo frame packet, the second server may identify the jumbo frame identifier carried in the first jumbo frame packet, and then may determine that the received packet is a jumbo frame packet. Further, the first jumbo frame packet may further carry a reply request related to the jumbo frame identifier, or the second server may be configured with a trigger condition. After the jumbo frame identifier is identified, the trigger condition is satisfied. Therefore, the second server may generate the reply packet based on the reply request or the satisfied trigger condition.

The reply packet is a response message generated by the second server based on the jumbo frame identifier in the first jumbo frame packet. After receiving the first jumbo frame packet, the second server performs processing based on the jumbo frame identifier in the packet, generates the reply packet, and transmits the reply packet back to the first server. The reply packet may carry information related to the first jumbo frame packet, and is configured for notifying the first server that the first jumbo frame packet has been received. In some embodiments, the reply packet may carry the jumbo frame identifier from the first jumbo frame packet.

The probe result refers to a status of the first transmission tunnel determined based on the time relationship between the transmitting time of the first jumbo frame packet and the receiving time of the reply packet, and is configured for indicating whether the first transmission tunnel is suitable for jumbo frame packet transmission. There are two types of probe results, including a result indicating that the first transmission tunnel is not suitable for jumbo frame transmission, and a result indicating that the first transmission tunnel is suitable for jumbo frame transmission. When the first transmission tunnel is suitable for jumbo frame transmission, a jumbo frame packet may be transmitted through the first transmission tunnel.

In this embodiment, an objective of determining the probe result for the first transmission tunnel based on the time relationship between the transmitting time of the first jumbo frame packet and the receiving time of the reply packet is to determine whether the transmission tunnel is suitable for jumbo frame transmission. When the first server transmits the first jumbo frame packet to the second server, if the second server supports jumbo frame transmission and works normally, the second server generates the reply packet and returns the reply packet within an appropriate time range. Therefore, through comparison on the time relationship between the transmitting time and the receiving time, a response speed of the first transmission tunnel can be indirectly reflected. Such determining is simple and effective, and helps the first server make an appropriate decision, to improve network transmission efficiency and performance.

In conclusion, in this embodiment, the first server may obtain status information about the first transmission tunnel by using the reply packet, to determine the probe result based on the time relationship. This manner not only avoids processing and analysis work of an intermediate network device and reduces processor load of the server, but also improves performance and a response speed of the server, and finally improves efficiency of detecting a transmission tunnel and efficiency of packet transmission between networks.

A specific process of obtaining the probe result in operation 303 is described in detail below.

In some implementations, the determining a probe result for the first transmission tunnel based on a time relationship between transmitting time of the first jumbo frame packet and receiving time of the reply packet includes:
receiving a third packet from the second server; and
determining the probe result for the first transmission tunnel based on the time relationship between the transmitting time of the first jumbo frame packet and the receiving time of the reply packet when determining that the third packet is the reply packet returned by the second server based on the jumbo frame identifier in the first jumbo frame packet.

In some embodiments, determining whether the third packet is the reply packet returned by the second server based on the jumbo frame identifier in the first jumbo frame packet includes: detecting whether the third packet carries predetermined data in the first jumbo frame packet. The predetermined data is, for example, a character string. When the third packet carries the predetermined data in the first jumbo frame packet, it is determined that the third packet is the reply packet returned by the second server based on the jumbo frame identifier in the first jumbo frame packet.

In some embodiments, determining whether the third packet is the reply packet returned by the second server based on the jumbo frame identifier in the first jumbo frame packet includes:

(1) Extract a transmitting packet identifier in the first jumbo frame packet, and extract a packet identifier in the third packet.

(2) Determine that the third packet is the reply packet returned by the second server based on the jumbo frame identifier in the first jumbo frame packet, when it is detected that the transmitting packet identifier matches the packet identifier in the third packet.

The third packet is a packet returned by the second server to the first server through the first transmission tunnel. The packet does not necessarily correspond to the currently transmitted first jumbo frame packet. The third packet is matched with the first jumbo frame packet to determine whether the third packet is the reply packet returned through the first transmission tunnel, so as to determine whether the first transmission tunnel is suitable for jumbo frame transmission.

In this embodiment of the present disclosure, the first jumbo frame packet may be periodically transmitted to the second server, to probe, in different probe time periods, whether the first transmission tunnel is suitable for jumbo frame transmission. In this case, packets returned by the second server may be replies in different periods. Alternatively, the second server may transmit a normal packet to the first server, to perform normal inter-network communication. Therefore, the second server may transmit a plurality of packets to the first server. Therefore, whether the packets are returned based on the jumbo frame identifier in the first jumbo frame packet needs to be verified.

The transmitting packet identifier is a unique identifier or mark that is carried in the first jumbo frame packet and that is configured for identifying the packet. The identifier may be a number, a character string, or code in another form, and is configured for uniquely identifying the first jumbo frame packet in a transmitting process. The packet identifier in the third packet is a unique identifier or mark that is carried in the third packet and that is configured for identifying the packet, and corresponds to the transmitting packet identifier. In some embodiments, when the packet identifier in the third packet is the same as the transmitting packet identifier, it is determined that the packet identifier in the third packet matches the transmitting packet identifier. In some embodiments, when a difference between the packet identifier in the third packet and the transmitting packet identifier is a predetermined difference, it is determined that the packet identifier in the third packet matches the transmitting packet identifier. Herein, the predetermined difference is, for example, a predetermined difference value.

For example, when the transmitting packet identifier in the first jumbo frame packet is extracted, a field or a location in which the transmitting packet identifier is located may be determined based on a format of the first jumbo frame packet or a protocol stipulation, and then the transmitting packet identifier is extracted from the first jumbo frame packet based on an offset, a length, or another indication of the field. An extraction method may be truncating based on a fixed length, or may be extracting the identifier by parsing a packet structure. A manner of extracting the packet identifier in the third packet is similar, and details are not described herein again.

In this embodiment, if the transmitting packet identifier matches the packet identifier in the third packet, it indicates that the third packet is the reply packet returned by the second server based on the jumbo frame identifier in the first jumbo frame packet. Subsequently, the probe result for the first transmission tunnel may be determined based on the time relationship between transmitting of the first jumbo frame packet and receiving of the reply packet.

In conclusion, in this embodiment, an association between the third packet and the transmitted first jumbo frame packet is determined by comparing the packet identifiers of the first jumbo frame packet and the third packet. Matching is performed on the identifiers of the packets, so that a plurality of packets returned by the second server can be filtered. Only when the identifiers match, it can be determined that the third packet is a reply returned based on the first jumbo frame packet. In this way, incorrect determining caused by a large quantity of packets, a network delay, and packet out-of-order can be effectively avoided, and reliability and accuracy of an entire jumbo frame transmission system can be improved.

In some implementations, the first server records the transmitting time when transmitting the first jumbo frame packet, and also records the receiving time when receiving the reply packet. Subsequently, the probe result may be obtained based on first duration between the transmitting time and the receiving time, including:

(1) Determine a difference between the transmitting time of the first jumbo frame packet and the receiving time of the reply packet as the first duration. The transmitting time is, for example, a time point at which the first jumbo frame packet starts to be transmitted. The transmitting time is, for example, a transmitting timestamp. The receiving time is, for example, a time point at which the reply packet starts to be received. The receiving time is, for example, a receiving timestamp.

(2) Determine a probe result indicating that the first transmission tunnel is suitable for jumbo frame transmission, when the first duration is less than or equal to a preset first threshold.

In some embodiments, the determining a probe result for the first transmission tunnel based on a time relationship between transmitting time of the first jumbo frame packet and receiving time of the reply packet further includes:
determining a probe result indicating that the first transmission tunnel is not suitable for jumbo frame transmission, when the first duration is greater than the first threshold.

The transmitting time is, for example, a time mark recorded when the first server starts to transmit the first jumbo frame packet, is configured for indicating a time point at which packet transmitting starts, and may be a timestamp value in a unit of millisecond, microsecond, or nanosecond. The receiving time is, for example, a time mark recorded when the second server starts to receive the reply packet, and is configured for indicating a time point at which packet receiving starts. Similarly, the receiving time is also in a unit of millisecond, microsecond, or nanosecond.

The first duration refers to a time difference between the transmitting time and the receiving time, that is, time from transmitting of the first jumbo frame packet to receiving of the reply packet. In this embodiment of the present disclosure, the first duration may be calculated by subtracting the transmitting time from the receiving time. A unit of the first duration is the same as the units of the transmitting time and the receiving time.

The transmitting time, the receiving time, and the first duration are configured for determining a jumbo frame tunnel attribute of the first transmission tunnel in this embodiment of the present disclosure, and whether the first transmission tunnel is suitable for jumbo frame transmission is determined based on different values of the first duration.

The first threshold is a time interval configured for determining the jumbo frame tunnel attribute of the first transmission tunnel in this embodiment of the present disclosure, is a preset value, and is configured for determining whether the first duration in which the reply packet is received is less than or equal to the time interval. A specific value of the first threshold needs to be set according to an actual situation and requirement, and is usually determined according to network transmission performance and a delay requirement. A smaller first threshold can improve detection sensitivity of the jumbo frame tunnel, and a larger first threshold can reduce load of the server. Therefore, selecting an appropriate first threshold needs to comprehensively consider a network environment and a performance requirement.

In this embodiment, when the reply packet is received, the first duration between the transmitting time and the receiving time is calculated. If the first duration is less than or equal to the preset first threshold, it indicates that the first transmission tunnel is suitable for jumbo frame transmission in this case. Therefore, after the first jumbo frame packet is received, the reply packet may be returned in a timely manner. Therefore, the probe result indicating that the first transmission tunnel is suitable for jumbo frame transmission may be obtained. On the contrary, if the first duration is greater than the first threshold, it may be considered that the first transmission tunnel is not suitable for jumbo frame transmission currently. After the first server transmits the first jumbo frame packet to the second server, due to a reason such as tunnel congestion or a delay, the first server does not receive in time a reply packet transmitted by a receiving server, and therefore obtains the probe result indicating that the first transmission tunnel is not suitable for jumbo frame transmission.

In conclusion, in this embodiment, the probe result is determined based on the first duration between the transmitting time and the receiving time, so that a transmission capability of the first transmission tunnel for a jumbo frame can be quickly obtained, and an intermediate network device on the transmission tunnel (for example, a device such as each server included in the transmission tunnel) does not need to process and analyze each data packet. This reduces processor load of the intermediate network device. Through determining of a magnitude relationship between the first duration and the first threshold, the first transmission tunnel may be effectively detected. Compared with a solution in which an intermediate network device on the transmission tunnel needs to return error information, in this embodiment, servers at two ends of the transmission tunnel perform probe, and the second server replies only when identifying the jumbo frame identifier. This reduces dependency on the intermediate network device, and improves reliability and stability of communication.

In some embodiments, the determining a probe result for the first transmission tunnel based on a time relationship between transmitting time of the first jumbo frame packet and receiving time of the reply packet further includes:
extracting reply time in the reply packet when the first duration is greater than the first threshold, the reply time indicating a time point at which the second server transmits the reply packet;
determining second duration between the transmitting time and the reply time and third duration between the receiving time and the reply time; and
determining a probe result indicating that the first transmission tunnel is not suitable for jumbo frame transmission, when a difference between the second duration and the third duration is greater than a preset second threshold.

The reply time is a time mark recorded when the second server transmits the reply packet, is configured for indicating a time point of packet transmitting, and may be a timestamp value in a unit of millisecond, microsecond, or nanosecond. The reply time is, for example, a moment before the reply packet is transmitted. Because the moment is close to time at which the reply packet starts to be transmitted, the reply time may be considered as a time point at which packet transmitting starts.

In practice, because network transmission has a delay and uncertainty, the first duration may be affected by a plurality of factors, such as network congestion and a transmission distance. To more accurately determine whether the first transmission tunnel is suitable for jumbo frame transmission, impact of these factors on the time interval needs to be considered. Therefore, in this embodiment of the present disclosure, after the reply time in the reply packet is extracted, second duration between the transmitting time and the reply time and third duration between the receiving time and the reply time may be determined. An actual transmission delay may be obtained by calculating a difference between the second duration and the third duration.

The second duration refers to a time interval between transmitting of the first jumbo frame packet and receiving of the reply packet, indicates a transmission delay of data from the first server to the second server, and may be configured for measuring time required for the data in a transmission process. The third duration refers to a time interval between the receiving time and the reply time, and indicates a time delay of obtaining the reply time by the first server after the second server transmits the reply packet.

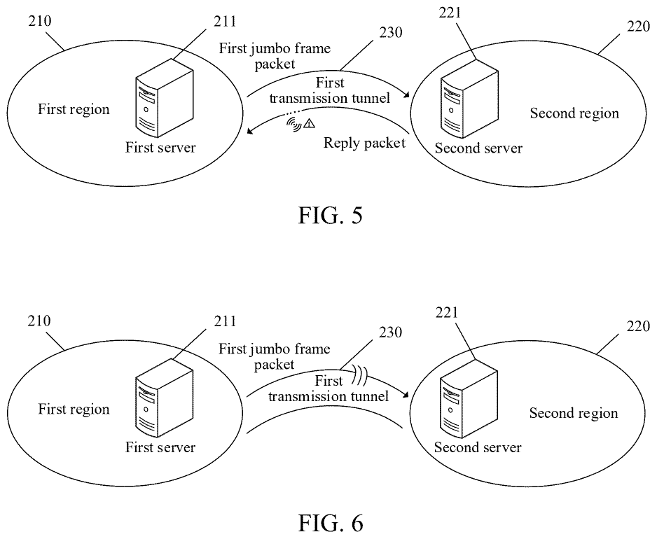

Referring to FIG. 5, FIG. 5 is a schematic diagram of a scenario in which a first server cannot receive a reply packet in a timely manner due to network congestion according to an embodiment of the present disclosure. The second duration and the third duration are also affected by a plurality of factors. For example, the second duration and the third duration may be affected by a network congestion status. If network congestion is severe, a delay of data transmission increases, causing the second duration and the third duration to become longer. The second duration and the third duration may also be affected by a transmission distance. A longer data transmission distance usually causes increases in the second duration and the third duration. The second duration and the third duration may also be affected by a network bandwidth, and a higher network bandwidth may reduce the second duration and the third duration. The second duration and the third duration may also be affected by network load. If a large quantity of data transmission activities exist on a network at the same time, the second duration and the third duration increase. Therefore, values of the second duration and the third duration depend on factors such as a network status, a transmission distance, a bandwidth, and network load. During actual application, the second duration and the third duration are affected differently, and these factors need to be considered and a suitable threshold needs to be set to determine the probe result.

The second threshold is a threshold set in a probe process, and is configured for determining whether a transmission delay is within an acceptable range. Therefore, the second threshold is a preset time range, and is configured for tolerating a fluctuation or an error of the transmission delay. A specific application scenario and a performance requirement need to be comprehensively considered for setting the second threshold. For example, a smaller second threshold can lead to a stricter probe result, and a larger second threshold can tolerate a larger fluctuation of the transmission delay.

In some embodiments, a probe result indicating that the first transmission tunnel is suitable for jumbo frame transmission is determined when a difference between the second duration and the third duration does not exceed the preset second threshold.

In this embodiment, when the difference between the second duration and the third duration is greater than the preset second threshold, the probe result indicating that the first transmission tunnel is not suitable for jumbo frame transmission is determined. It indicates that the difference exceeds an acceptable transmission delay range. In this case, the transmission delay is relatively high, and cannot satisfy a requirement of a jumbo frame tunnel. The jumbo frame tunnel usually requires a relatively low transmission delay, to ensure that data can be transmitted completely within relatively short time. When the transmission delay exceeds the set second threshold, data transmission efficiency may be reduced, real-time performance may be reduced, or a performance requirement of an application cannot be satisfied. Therefore, when the difference between the second duration and the third duration is greater than the preset second threshold, it may be determined that the first transmission tunnel is not suitable for jumbo frame transmission. Such a probe result may help a system perform further determining and decision, to ensure validity of data transmission and satisfaction of the performance requirement. In some embodiments, the transmitting the first jumbo frame packet to a second server through the first transmission tunnel includes:
successively transmitting the first jumbo frame packet to the second server through the first transmission tunnel in each of a plurality of probe time periods, two adjacent probe time periods being separated by a preset time interval. In other words, the first server may periodically transmit the first jumbo frame packet. A transmitting period is the preset time interval.

In this embodiment of the present disclosure, the probe result may alternatively be obtained when no reply packet returned by the second server is received, including:
determining the probe result indicating that the first transmission tunnel is not suitable for jumbo frame transmission, when no reply packet returned by the second server based on the jumbo frame identifier in the first jumbo frame packet is received in a current probe time period.

In this embodiment, in a normal case, if the first transmission tunnel is suitable for jumbo frame transmission and the second server works normally, the second server may return the reply packet based on the jumbo frame identifier in the first jumbo frame packet. Therefore, the probe result indicating that the first transmission tunnel is not suitable for jumbo frame transmission may be obtained when no reply packet returned by the second server based on the jumbo frame identifier in the first jumbo frame packet is received in the current probe time period. In other words, the probe result indicating that the first transmission tunnel is not suitable for jumbo frame transmission in the current probe time period is determined.

There are a plurality of cases in which no reply packet returned by the second server based on the jumbo frame identifier in the first jumbo frame packet is received. Referring to FIG. 6, FIG. 6 is a schematic diagram of a scenario in which a first jumbo frame packet cannot be forwarded through a first transmission tunnel according to an embodiment of the present disclosure. In FIG. 6, a communication fault may exist on the first transmission tunnel. Due to a network problem or a transmission error, the first jumbo frame packet cannot reach the second server, or the reply packet cannot be returned to the first server. Alternatively, the second server may be incapable of responding to the first jumbo frame packet normally due to a fault or another reason, and consequently, the second server cannot return the reply packet. In this case, the second server cannot identify the jumbo frame identifier or process the first jumbo frame packet. Alternatively, the first transmission tunnel may not be suitable for jumbo frame transmission, and the second server cannot receive the forwarded first jumbo frame packet because the second server cannot identify the jumbo frame identifier. In conclusion, that no reply packet is received may be considered as an indication that the first transmission tunnel is not suitable for jumbo frame transmission.

In conclusion, in this embodiment, when no reply packet returned by the second server based on the first jumbo frame packet is received, it may be concluded that the first transmission tunnel is not suitable for jumbo frame transmission, to obtain the probe result indicating that the first transmission tunnel is not suitable for jumbo frame transmission. Such a result may help identify a communication problem, detect a feature of the first transmission tunnel, and take corresponding processing measures.

For example, the following describes the foregoing operations by using a specific embodiment.

The first server may set a preset time interval, that is, a probe period, for example, 10 s. At the beginning of each probe time period, a first jumbo frame packet corresponding to a transmitting packet identifier is transmitted through the first transmission tunnel. For example, a first jumbo frame packet identified as 1001 is transmitted in the first probe time period, a first jumbo frame packet identified as 1002 is transmitted in a next probe time period, and as on. After completing transmitting the first jumbo frame packet, the first server records transmitting time of transmitting the packet in the current probe time period, for example, a transmitting timestamp last-tx-jumbo-ping-ts, and receiving time of receiving a reply packet, for example, a receiving timestamp last-rx-jumbo-ping-ts, which respectively represent timestamps of transmitting and receiving packets last time.

Because the first jumbo frame packet in the current period is just transmitted, last-tx-jumbo-ping-ts is after last-rx-jumbo-ping-ts, that is, no reply packet corresponding to the first jumbo frame packet in the current probe time period is received. In this case, timing is started at last-tx-jumbo-ping-ts, and a response interval is determined. When the reply packet is received, the first duration is compared with the first threshold. The first threshold may be set to 1 s. To be specific, if the first duration is less than or equal to 1 s, a probe result indicating that the first transmission tunnel is suitable for jumbo frame transmission may be obtained. If the first duration is greater than 1 s, a probe result indicating that the first transmission tunnel is not suitable for jumbo frame transmission may be obtained.

When the first duration is greater than 1 s, error determining may further be performed. In this case, the reply time in the reply packet is extracted, the second duration between the transmitting time and the reply time and the third duration between the receiving time and the reply time are calculated, and the preset second threshold, such as 5 s, is obtained. The second threshold is less than the detection period. If a difference obtained by subtracting the second duration from the third duration is greater than 5 s, it is still considered that the first transmission tunnel is not suitable for jumbo frame transmission.

In addition, if no reply packet corresponding to the current period is obtained in a probe time period, a probe result indicating that the first transmission tunnel is not suitable for jumbo frame transmission in the current probe time period is obtained.

In some implementations, when no reply packet returned by the second server is received, after the probe result indicating that the first transmission tunnel is not suitable for jumbo frame transmission is obtained, error determining may be further performed based on subsequent reception of a corresponding reply packet, to adjust the probe result, including:

(1) When a reply packet returned by the second server based on a jumbo frame identifier in a first jumbo frame packet transmitted in a previous probe time period (for example, a last probe time period) is received in a probe time period, determine target time of receiving the reply packet.

(2) Determine transmitting time of the first jumbo frame packet transmitted in the previous probe time period, and determine a delay interval between the transmitting time and the target time.

(3) Adjust the probe result when the delay interval is less than or equal to a preset error period, to obtain a probe result indicating that the first transmission tunnel is suitable for jumbo frame transmission.

In this embodiment of the present disclosure, after it is determined that the first server can transmit a jumbo frame packet to the second server through the first transmission tunnel, it is determined that the first transmission tunnel is suitable for jumbo frame transmission. When the first server does not receive the reply packet returned by the second server, it only indicates that no corresponding reply packet is received in the current probe time period. In this case, if a reply packet to be received in another subsequent period is received in the period, whether the first transmission tunnel is suitable for jumbo frame transmission may still be determined based on the error period.

The target time refers to a time mark recorded when the first server receives, in a subsequent probe time period, a reply packet corresponding to a previous probe time period, is configured for indicating a time point of packet receiving, and may be a timestamp value in a unit of millisecond, microsecond, or nanosecond.

The delay interval refers to a time difference between the transmitting time and the target time, that is, time from transmitting of the first jumbo frame packet to receiving of the reply packet in the subsequent period. In this embodiment of the present disclosure, the delay interval may be calculated by subtracting the transmitting time from the target time. A unit of the delay interval is the same as the units of the transmitting time and the target time.

The error period is a threshold set in a target probe process, and is configured for determining whether a maximum delay of the first transmission tunnel is within an acceptable range. Therefore, the error period is a preset time range, and is configured for tolerating a maximum fluctuation or error of the transmission delay. Similarly, a specific application scenario and a performance requirement need to be comprehensively considered for setting the error period. For example, a smaller error period can lead to a stricter probe result, and a larger error period can tolerate a larger fluctuation of the transmission delay.

During network transmission, transmission time of a data packet has particular uncertainty. Even in an ideal case, after the first server transmits a probe packet, the second server immediately returns a reply packet. However, the reply packet may be delayed due to factors such as network congestion and a delay. Consequently, a time interval between transmitting of the probe packet and receiving of the reply packet may have deviation. The probe result is adjusted when the delay interval is less than or equal to the preset error period, to obtain the probe result indicating that the first transmission tunnel is suitable for jumbo frame transmission, so that uncertainty of network transmission and an error caused by a delay are considered.

In this embodiment, to accurately determine whether the first transmission tunnel is suitable for jumbo frame transmission, an error caused by a maximum delay needs to be considered. The preset error period is a preset threshold, and is configured for determining whether the delay is within an acceptable range. When the delay interval is less than or equal to the error period, it means that the delay error is relatively small, and it may be considered that the first transmission tunnel is suitable for jumbo frame transmission. In other words, if the time interval between transmitting of the probe packet and receiving of the reply packet is within an acceptable delay range, it can be properly considered that the first transmission tunnel is a tunnel suitable for jumbo frame transmission. Such adjustment can improve accuracy of the probe result, and avoid generation of misjudgment and an incorrect result.

For example, the error period is related to the probe period. Further, the error period may be a multiple of the probe period. For example, when the probe period is 10 s, the error period may be three times the probe period, that is, the error period is 30 s.

In some implementations, the first jumbo frame packet is periodically transmitted to the second server. Regardless of a manner in a process of obtaining the probe result indicating that the first transmission tunnel is not suitable for jumbo frame transmission, retry may be performed several times, and an accumulated quantity of probe results indicating that the first transmission tunnel is not suitable for jumbo frame transmission is determined. The transmission limit value of the first transmission tunnel is decreased when the accumulated quantity reaches a third threshold. The third threshold is a preset fixed value, and means that when an accumulated quantity of failure times reaches the value, it may be determined that the first transmission tunnel is not suitable for jumbo frame transmission. According to an actual requirement, the third threshold may be set according to conditions such as a network environment and transmission load. Generally, impact on aspects such as a network bandwidth and server performance needs to be minimized while ensuring accuracy.

For example, it is assumed that the third threshold is set to 3. In this case, when the probe result indicating that the first transmission tunnel is not suitable for jumbo frame transmission is obtained at three consecutive times of transmitting the first jumbo frame packet, it may be determined that the first transmission tunnel is not suitable for jumbo frame transmission, thereby decreasing the transmission limit value of the first transmission tunnel. In addition, analysis and determining further need to be performed according to actual situations. For example, other possible impact such as network abnormality and an interference factor is eliminated.

In some embodiments, the method in this embodiment of the present disclosure further includes:
determining an accumulated quantity of probe results indicating that the first transmission tunnel is not suitable for jumbo frame transmission, when the probe result indicating that the first transmission tunnel is not suitable for jumbo frame transmission is determined in a current probe time period; and
continuing to transmit the first jumbo frame packet to the second server through the first transmission tunnel in a next probe time period when the accumulated quantity is less than the preset third threshold; or
decreasing the transmission limit value of the first transmission tunnel when the accumulated quantity reaches the third threshold.

In some embodiments, the decreasing the transmission limit value of the first transmission tunnel includes: setting the transmission limit value of the first transmission tunnel to a first value. The first value in this embodiment of the present disclosure refers to a minimum length value for jumbo frame transmission. A packet whose length is less than the first value is a packet of a normal size, and a packet whose length is greater than the first value is a jumbo frame packet. For example, the first value may be 1500 bytes, that is, the jumbo frame packet is a packet whose length is greater than 1500 bytes. In this case, a data packet whose length is less than the first value can be normally transmitted through the first transmission tunnel. In other words, a non-jumbo-frame data packet is transmitted through the first transmission tunnel.

In some embodiments, the decreasing the transmission limit value of the first transmission tunnel includes: extracting a packet length value of the first jumbo frame packet, obtaining a second value based on the packet length value of the first jumbo frame packet, and setting the transmission limit value of the first transmission tunnel to the second value, the second value being less than the packet length value of the first jumbo frame packet and greater than the first value. The second value is a value less than the packet length value of the first jumbo frame packet and greater than the first value. For example, if the packet length value of the first jumbo frame packet is 5000 bytes, and the first value is 1500 bytes, the second value may be any value between 1500 bytes and 5000 bytes. Further, the second value in this embodiment of the present disclosure approaches the packet length value of the first jumbo frame packet. In this way, a jumbo frame forwarding capability of the first transmission tunnel can be probed level by level.

In this embodiment, the first jumbo frame packet is periodically transmitted and whether the accumulated quantity reaches the third threshold is determined, so that whether to transmit the first jumbo frame packet to the second server through the first transmission tunnel in a next probe time period may be determined. When the accumulated quantity does not reach the preset third threshold, even if the first transmission tunnel temporarily fails to be determined to be suitable for jumbo frame transmission, probe is still performed in the next probe time period. This is because a network environment may have a particular fluctuation, and a status of the transmission tunnel may change. The transmission limit value of the first transmission tunnel is decreased only when the accumulated quantity reaches the preset third threshold.

In conclusion, in this embodiment of the present disclosure, the first transmission tunnel may continue to be probed in a subsequent probe time period after the transmission limit value of the first transmission tunnel is decreased. In this way, the transmission limit value is decreased and the first transmission tunnel is probed one or more times, until an appropriate transmission limit value is found. In this manner, a maximum packet length for transmission actually supported by the first transmission tunnel can be determined, to properly perform transmission of a jumbo frame packet, thereby improving packet transmission efficiency.

Operation 304: Obtain a to-be-transmitted second jumbo frame packet and transmit the second jumbo frame packet to the second server through the first transmission tunnel when the probe result indicates that the first transmission tunnel is suitable for jumbo frame transmission.

When the probe result indicates that the first transmission tunnel is suitable for jumbo frame transmission, it means that the first transmission tunnel can support transmission of a jumbo frame packet. The first transmission tunnel is determined to be suitable for jumbo frame transmission, so that it can be determined that the tunnel has a capability of transmitting a jumbo frame packet. Therefore, the to-be-transmitted second jumbo frame packet can be transmitted through this tunnel.

The second jumbo frame packet is an Ethernet frame packet that needs to be transmitted in an actual network communication process.

In this embodiment, when the first transmission tunnel is determined to be suitable for jumbo frame transmission, the first transmission tunnel has a capability of transmitting a jumbo frame packet. Therefore, when the probe result indicates that the first transmission tunnel is suitable for jumbo frame transmission, it means that the tunnel has a sufficient bandwidth and processing capability to transmit a large jumbo frame packet. The second jumbo frame packet is transmitted through the first transmission tunnel, so that data splitting and recombining operations during transmission can be reduced, transmission efficiency can be improved, communication resources can be better used, and a resource waste caused by frequent data packet splitting and recombining can be avoided. In addition, the first transmission tunnel used as a jumbo frame transmission tunnel is selected for transmission, so that processor load of the server can be reduced, performance and a response speed of the server can be improved, and network transmission efficiency and performance can be effectively improved.

In some implementations, the jumbo frame tunnel is a tunnel for transmitting a packet having a length greater than the first value. If the first transmission tunnel is not suitable for jumbo frame transmission, the transmission limit value of the first transmission tunnel may be further adjusted, including:

(1) Set the transmission limit value of the first transmission tunnel to the first value when the probe result indicating that the first transmission tunnel is not suitable for jumbo frame transmission is obtained.

(2) Extract the packet length value of the first jumbo frame packet, obtain the second value based on the packet length value of the first jumbo frame packet, and set the transmission limit value of the first transmission tunnel to the second value.

The second value is less than the packet length value of the first jumbo frame packet and greater than the first value.

In the foregoing embodiment, the action of transmitting the second jumbo frame packet when the probe result indicates that the first transmission tunnel is suitable for jumbo frame transmission is described. However, if the probe result indicating that the first transmission tunnel is not suitable for jumbo frame transmission is obtained, the first transmission tunnel needs to be adjusted.

In this embodiment, when the probe result indicating that the first transmission tunnel is not suitable for jumbo frame transmission is obtained, the transmission limit value of the first transmission tunnel is adjusted in a plurality of manners. For example:

When the probe result indicating that the first transmission tunnel is not suitable for jumbo frame transmission is obtained, the transmission limit value of the first transmission tunnel is adjusted to the first value. In this way, a transmission capability of a non-jumbo-frame tunnel can be limited, so that the non-jumbo-frame tunnel cannot transmit a packet whose length is greater than the first value.

The jumbo frame tunnel is usually configured for transmitting a relatively large data packet, and the non-jumbo-frame tunnel may be suitable for transmission of a small packet or a case in which a requirement on a transmission speed is low. The transmission limit value of the non-jumbo-frame tunnel is adjusted to the first value, so that a transmission capability of the tunnel can be reduced, thereby avoiding a waste of network resources and processor load.

In addition, when the transmission limit value of the first transmission tunnel is adjusted, the packet length value of the first jumbo frame packet may be further extracted, the second value is obtained based on the packet length value of the first jumbo frame packet, and the transmission limit value of the first transmission tunnel is adjusted to the second value. The transmission limit value may be dynamically adjusted according to different transmission tunnel statuses during probe of a jumbo frame, to optimize tunnel detection efficiency and network packet transmission efficiency.

For example, an example in which the transmission limit value of the first transmission tunnel is adjusted to the second value is used for description.

It is assumed that the transmission limit value of the first transmission tunnel is limited to 5000 bytes at the beginning, which indicates that a jumbo frame packet with a length of a maximum of 5000 bytes can be transmitted. However, during actual probe, after the first jumbo frame packet of 5000 bytes is transmitted, a probe result indicating that the first transmission tunnel is not suitable for jumbo frame transmission is obtained, which indicates that the tunnel actually does not support forwarding of a packet with a length of 5000 bytes. However, the tunnel may further support forwarding of a jumbo frame packet of another size.

Based on this, in this embodiment, the transmission limit value of the first transmission tunnel is adjusted level by level. For example, the transmission limit value is adjusted to 4000 bytes, a first jumbo frame packet with a length of 4000 bytes is configured, and whether the first transmission tunnel supports a jumbo frame forwarding capability continues to be probed by using the packet. If a probe result indicating that the first transmission tunnel is suitable for jumbo frame transmission is obtained in this case, the second value, that is, 4000 bytes, may be used as a final transmission limit value of the first transmission tunnel. On the contrary, if a probe result indicating that the first transmission tunnel is not suitable for jumbo frame transmission is obtained, the transmission limit value of the first transmission tunnel may continue to be decreased until an appropriate value is found. In this way, a maximum packet length for transmission actually supported by the first transmission tunnel can be determined, so as to properly forward a jumbo frame packet and improve packet transmission efficiency.

According to the foregoing operation 301 to operation 304, the first server transmits, to the second server through the first transmission tunnel, the first jumbo frame packet carrying the added jumbo frame identifier. When the second server can receive the first jumbo frame packet, the second server returns the reply packet to the first server based on the jumbo frame identifier. Finally, the probe result is determined based on a time relationship between packet transmitting and receiving. Compared with a solution in which an intermediate network device needs to return error information in a related technology, the method in this embodiment of the present disclosure prevents the intermediate network device from returning error information. In addition, the first server determines, based on the reply packet, whether it is suitable for jumbo frame transmission, so that processor load of the intermediate network device is reduced, tunnel detection efficiency can be improved, and efficiency of packet transmission between networks can be improved.

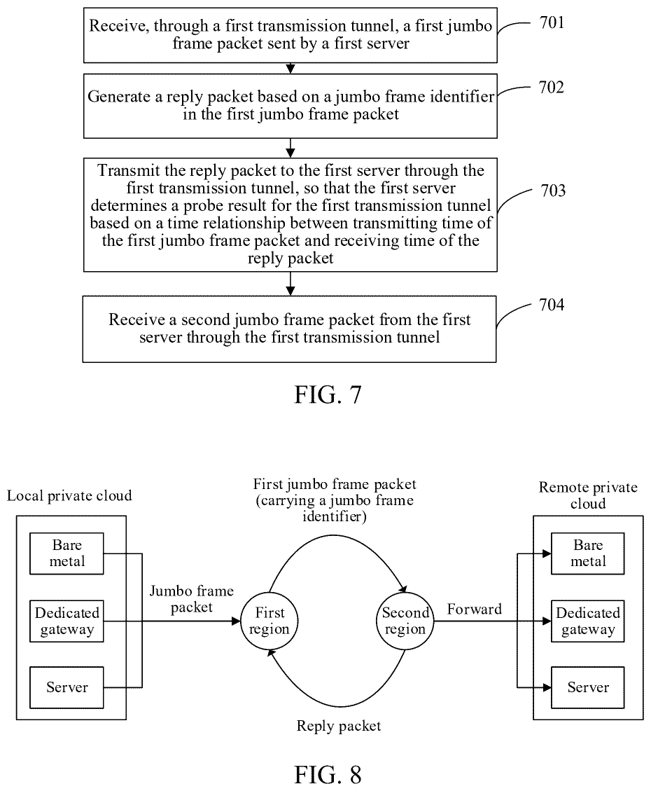

Referring to FIG. 7, FIG. 7 is another schematic flowchart of a packet transmission method according to an embodiment of the present disclosure. The packet transmission method may be applied to the second server in the foregoing embodiment, or the second region in which the second server is located. The packet transmission method includes the following operations.

Operation 701: Receive, through a first transmission tunnel, a first jumbo frame packet transmitted by a first server.

The first jumbo frame packet carries a jumbo frame identifier, and the first transmission tunnel is one of at least one transmission tunnel for communicating with the first server.

The first jumbo frame packet is a jumbo frame packet. The jumbo frame packet is an Ethernet frame packet whose length is greater than or equal to 1500 bytes. Probing means probing a transmission tunnel between networks. Therefore, the first jumbo frame packet is an Ethernet frame packet configured for probing whether the transmission tunnel between the networks supports jumbo frame forwarding.

The jumbo frame identifier is identification information carried in the first jumbo frame packet, is additional information carried in the packet, and is configured for identifying the packet as a jumbo frame packet. After receiving the first jumbo frame packet, the second server may identify the jumbo frame identifier from the first jumbo frame packet, to determine that the received packet is a jumbo frame packet, and further perform feedback based on the jumbo frame identifier.

At least one transmission tunnel may be provided between the first server and the second server, and each transmission tunnel may include a different network path or link. In this embodiment of the present disclosure, whether each of the plurality of transmission tunnels supports jumbo frame packet forwarding may be probed, and the first transmission tunnel is one of the at least one transmission tunnel. To be specific, the first transmission tunnel is a transmission tunnel selected for current probe and forwarding in the at least one transmission tunnel.

Because the first jumbo frame packet may alternatively be a packet including communication data, after receiving the first jumbo frame packet, the second server may remove the jumbo frame identifier in the first jumbo frame packet, and then forward the first jumbo frame packet, for example, forward the first jumbo frame packet to another device in the second region in which the second server is located. This is not specifically limited herein.

In conclusion, in this embodiment, the first jumbo frame packet transmitted by the first server is received through the first transmission tunnel, and whether the first transmission tunnel supports jumbo frame transmission may be detected. Subsequently, the second server may transmit a reply packet based on the jumbo frame identifier, so that the first server detects a jumbo frame forwarding capability of the first transmission tunnel.

Operation 702: Generate a reply packet based on the jumbo frame identifier in the first jumbo frame packet.

Operation 703: Transmit the reply packet to the first server through the first transmission tunnel, so that the first server determines a probe result for the first transmission tunnel based on a time relationship between transmitting time of the first jumbo frame packet and receiving time of the reply packet.

After receiving the first jumbo frame packet, the second server may normally forward the first jumbo frame packet to another device in a network in which the second server is located. After receiving the first jumbo frame packet, the second server may identify the jumbo frame identifier carried in the first jumbo frame packet, and then may determine that the received packet is a jumbo frame packet. Further, the first jumbo frame packet may further carry a reply request related to the jumbo frame identifier, or the second server may be configured with a trigger condition. After the jumbo frame identifier is identified, the trigger condition is satisfied. Therefore, the second server may generate the reply packet based on the reply request or the satisfied trigger condition.

The reply packet is a response message generated by the second server based on the jumbo frame identifier in the first jumbo frame packet. After receiving the first jumbo frame packet, the second server performs processing based on the jumbo frame identifier in the packet, generates the reply packet, and transmits the reply packet back to the first server. The reply packet may be information related to the first jumbo frame packet, and is configured for notifying the first server that the first jumbo frame packet is received, so that the first server determines whether the first transmission tunnel is suitable for jumbo frame transmission.

The probe result refers to a status of the first transmission tunnel determined based on the time relationship between transmitting of the first jumbo frame packet and receiving of the reply packet, and is configured for indicating whether the first transmission tunnel is suitable for jumbo frame transmission. There are two types of probe results, including a result indicating that the first transmission tunnel is not suitable for jumbo frame transmission, where the first transmission tunnel cannot forward a jumbo frame packet under this result; or a result indicating that the first transmission tunnel is suitable for jumbo frame transmission, where the first transmission tunnel can normally forward a jumbo frame packet under this result.

In this embodiment, determining the probe result for the first transmission tunnel based on the time relationship between transmitting of the first jumbo frame packet and receiving of the reply packet is to determine whether the transmission tunnel is suitable for jumbo frame transmission. When the first server transmits the first jumbo frame packet to the second server, if the second server supports jumbo frame transmission and works normally, the second server generates the reply packet and transmits back the reply packet within an appropriate time range. Therefore, through comparison on the time relationship between packet transmitting and receiving, a response speed of the transmission tunnel can be indirectly reflected. Such determining is simple and effective, and helps the first server make an appropriate decision, to improve network transmission efficiency and performance.

In conclusion, in this embodiment, the first server may obtain status information about the first transmission tunnel by using the reply packet, to determine the probe result based on the time relationship between packet transmitting and receiving. This manner not only avoids processing and analysis work of an intermediate network device and reduces processor load of the server, but also improves performance and a response speed of the server, and finally improves efficiency of detecting a tunnel and efficiency of packet transmission between networks.

In some implementations, the second server may extract the jumbo frame identifier of the first jumbo frame packet, and generate the reply packet based on the jumbo frame identifier, including:

(1) Extract header information of the first jumbo frame packet, and extract the jumbo frame identifier from the header information of the first jumbo frame packet.

(2) Generate reply header information based on the jumbo frame identifier, and generate the reply packet based on the reply header information.

The header information of the first jumbo frame packet refers to a group of fields or data located in a former part in the packet, that is, a header of the packet, is configured for describing metadata and control information of the packet, and includes parameters and attributes related to packet transmission, parsing, and processing. Extracting the header information of the first jumbo frame packet may be performed according to a specific transport protocol and packet format. This is not specifically limited herein.

In this embodiment, after the jumbo frame identifier is obtained, the reply header information may be generated based on the jumbo frame identifier, and the reply packet is generated based on the reply header information. Specifically, a related field, such as a number of the first transmission tunnel and a reply status, that needs to be included in the reply header information is determined based on the jumbo frame identifier. Subsequently, a header of the reply packet is constructed according to a format and a field specified in a protocol, including the reply header information and another necessary field. Additional information, such as additional data, may be added to a data part of the reply packet as required. This is not specifically limited herein.

For example, the reply header information may be an acknowledgment jumbo frame identifier (Acknowledgment Jumbo-Pong, ACK Jumbo-Pong). The formed reply packet is an acknowledgment (ACK) packet, may be written as an ACK (Jumbo-Pong), is used as a Pong response, and is an acknowledgment mechanism in packet transmission, configured for acknowledging a received data packet or the first jumbo frame packet. The reply packet is configured for performing ACK, to notify a transmitter that a specific data packet or the first jumbo frame packet is received. After receiving the ACK packet, the first server may acknowledge successful transmission of the data or the probe result for the first transmission tunnel.

In conclusion, in this embodiment, to probe support for jumbo frame transmission, the reply header information needs to be generated based on the jumbo frame identifier, and the reply packet needs to be generated based on the reply header information. Content of the reply packet is simple. Generating the simple packet only by returning the header information is an in-band probe method, which can reduce bandwidth costs of jumbo frame probe, does not need to additionally add other information, and does not significantly change data. Therefore, modification costs are low, and probe efficiency is high.

In some implementations, the second server may write, into the reply packet, a reply timestamp recorded when the reply packet is transmitted, so that the first server further performs processing based on the reply timestamp, including:
writing, into the reply packet, the reply timestamp recorded when the reply packet is transmitted, and transmitting the reply packet to the first server through the first transmission tunnel, so that the first server determines the probe result for the first transmission tunnel based on a time relationship between a transmitting timestamp of transmitting the first jumbo frame packet, a receiving timestamp of receiving the reply packet, and the reply timestamp.

The reply timestamp is a time mark recorded when the second server transmits the reply packet, is configured for indicating a time point of packet transmitting, and may be a timestamp value in a unit of millisecond, microsecond, or nanosecond. In this embodiment of the present disclosure, the second server may write, into the reply packet, the reply timestamp recorded when the reply packet is transmitted, and transmit the reply packet to the first server through the first transmission tunnel.

When the first duration is greater than the first threshold, the first server needs to extract the reply timestamp in the reply packet, perform error determining, and obtain the probe result. In practice, because network transmission has a delay and uncertainty, the first duration may be affected by a plurality of factors, such as network congestion and a transmission distance. To more accurately determine whether the first transmission tunnel is suitable for jumbo frame transmission, impact of these factors on the time interval needs to be considered. Therefore, in this embodiment of the present disclosure, after extracting the reply timestamp in the reply packet, the first server may determine second duration between the transmitting timestamp and the reply timestamp and third duration between the receiving timestamp and the reply timestamp. An actual transmission delay may be obtained by calculating a difference between the second duration and the third duration.

In addition, a detailed process of determining, by the first server, the probe result for the first transmission tunnel based on the time relationship between the transmitting timestamp of transmitting the first jumbo frame packet, the receiving timestamp of receiving the reply packet, and the reply timestamp has been described in the foregoing embodiment. Details are not described herein again.

Operation 704: Receive a second jumbo frame packet from the first server through the first transmission tunnel.

The second jumbo frame packet is transmitted by the first server when the probe result indicates that the first transmission tunnel is suitable for jumbo frame transmission.

When the probe result indicates that the first transmission tunnel is suitable for jumbo frame transmission, it means that the first transmission tunnel can support transmission of a jumbo frame packet. The first transmission tunnel is determined to be suitable for jumbo frame transmission, so that it can be determined that the tunnel has a capability of transmitting a jumbo frame packet. Therefore, the to-be-transmitted second jumbo frame packet can be transmitted through this tunnel.

The second jumbo frame packet is a jumbo frame packet. The jumbo frame packet is an Ethernet frame packet whose length is greater than or equal to 1500 bytes. A target is transmission in an actual application after tunnel detection is completed. Therefore, the second jumbo frame packet is an Ethernet frame packet that needs to be transmitted in an actual network communication process.

In this embodiment, the first transmission tunnel is determined as a jumbo frame tunnel, and has a capability of transmitting a jumbo frame packet. Therefore, when the probe result indicates that the first transmission tunnel is suitable for jumbo frame transmission, it means that the tunnel has a sufficient bandwidth and processing capability to transmit a large jumbo frame packet. The second jumbo frame packet is transmitted through the first transmission tunnel, so that data splitting and recombining operations during transmission can be reduced, transmission efficiency can be improved, communication resources can be better used, and a resource waste caused by frequent data packet splitting and recombining can be avoided. In addition, the first transmission tunnel used as a jumbo frame tunnel is selected for transmission, so that processor load of the server can be reduced, performance and a response speed of the server can be improved, and network transmission efficiency and performance can be effectively improved.

According to the foregoing operation 701 to operation 704, in this embodiment of the present disclosure, a first jumbo frame packet transmitted by a first server is received through a first transmission tunnel, the first jumbo frame packet carrying a jumbo frame identifier, and the first transmission tunnel being one of at least one transmission tunnel for communicating with the first server; a reply packet is generated based on the jumbo frame identifier in the first jumbo frame packet; the reply packet is transmitted to the first server through the first transmission tunnel, so that the first server determines a probe result for the first transmission tunnel based on a time relationship between transmitting time of the first jumbo frame packet and receiving time of the reply packet; and a second jumbo frame packet transmitted by the first server is received through the first transmission tunnel, the second jumbo frame packet being transmitted by the first server when the probe result indicates that the first transmission tunnel is suitable for jumbo frame transmission. The first server transmits, to the second server through the first transmission tunnel, the first jumbo frame packet carrying the added jumbo frame identifier. When the second server can receive the first jumbo frame packet, the second server returns the reply packet to the first server based on the jumbo frame identifier, to determine the probe result based on a time relationship between packet transmitting and receiving. Compared with a solution in which an intermediate network device needs to return error information in a related technology, the method in this embodiment of the present disclosure prevents the intermediate network device from returning error information. In addition, the first server determines, based on the reply packet, whether it is suitable for jumbo frame transmission, so that processor load of the intermediate network device is reduced, tunnel detection efficiency can be improved, and efficiency of packet transmission between networks can be improved.

With reference to the method described in the foregoing embodiment, the following further provides detailed descriptions by using an example.

An example in which a jumbo frame forwarding capability of a first transmission tunnel between a first server and a second server is probed is used. Referring to FIG. 2, this environment includes the first server deployed in the first region and the second server deployed in the second region. The first server may route, to a corresponding tunnel (for example, a first transmission tunnel), a packet that needs to be transmitted in the first region, to transmit the packet to the second server. The second server may also route, to a corresponding tunnel, a packet that needs to be transmitted in the second region, to transmit the packet to the first server.

For better description of the embodiments of the present disclosure, referring to FIG. 8 together, FIG. 8 is a schematic diagram of interaction of a packet transmission system according to an embodiment of the present disclosure.

In FIG. 8, a first region is a local private cloud (LOCAL-VPC) network, and is provided with bare metal, a dedicated gateway, and a server. The bare metal refers to a physical server, and is also referred to as a bare metal server. The dedicated gateway refers to a device or a service configured to connect a local network to a cloud service provider or another remote network. The server provides better computing and storage resources, which may be used as a first server. Similarly, a second region is a remote private cloud (REMOTE-VPC) network. Settings of the second region are the same as those of the first region, and may be used as a second server. Details are not described herein again.

After the first server transmits a first jumbo frame packet to the second server through a first transmission tunnel, if the first transmission tunnel supports jumbo frame forwarding, after receiving the first jumbo frame packet, the second server transmits a reply packet to the first server. The following describes a specific execution process.

In this embodiment, an example in which the packet transmission apparatus specifically exists in the first server is used for description.

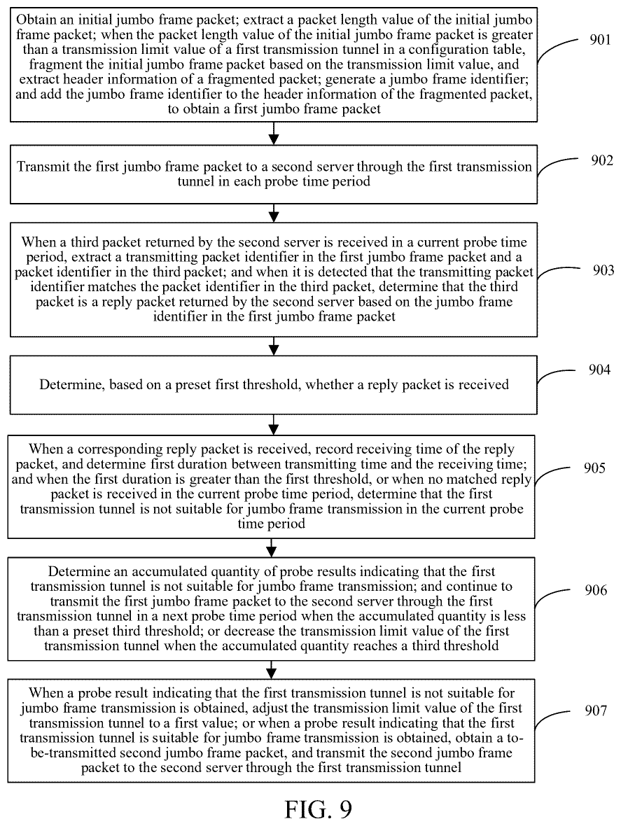

Referring to FIG. 9 together, FIG. 9 is a complete schematic flowchart of a packet transmission method according to an embodiment of the present disclosure. A procedure of the method may include the following operations.

Operation 901: Obtain an initial jumbo frame packet; extract a packet length value of the initial jumbo frame packet; when the packet length value of the initial jumbo frame packet is greater than a transmission limit value of a first transmission tunnel in a configuration table, fragment the initial jumbo frame packet based on the transmission limit value, and extract header information of a fragmented packet; generate a jumbo frame identifier; and add the jumbo frame identifier to the header information of the fragmented packet, to obtain a first jumbo frame packet.

After obtaining the initial jumbo frame packet, the first server first performs routing, extracts the packet length value of the initial jumbo frame packet after selecting the first transmission tunnel, performs comparison with the transmission limit value, that is, an MTU value, in the configuration table (tunnel_jumbo_conifg), and determines, by comparing packet lengths, whether to perform fragmentation. If fragmentation is needed, the initial jumbo frame packet is fragmented based on the MTU value, and then an NSH header (Jumbo-Ping) is added to header information of a packet to be forwarded after fragmentation, to identify that the packet is a jumbo frame packet. If fragmentation is not needed, an NSH header (Jumbo-Ping) is directly added to the header information of the packet, to finally obtain the first jumbo frame packet.

Operation 902: Transmit the first jumbo frame packet to a second server through the first transmission tunnel in each probe time period.

An example in which duration of the probe time period is 10 s is used for description. After entering each probe time period, the first server transmits the first jumbo frame packet to the second server through the first transmission tunnel. The first jumbo frame packet transmitted in each probe time period carries a transmitting packet identifier corresponding to the current period. For example, a transmitting packet identifier transmitted in the current period is 1001, a transmitting packet identifier in a first jumbo frame packet transmitted in a next probe time period is 1002, and so on.

Operation 903: When a third packet returned by the second server is received in a current probe time period, extract a transmitting packet identifier in the first jumbo frame packet and a packet identifier in the third packet; and when it is detected that the transmitting packet identifier matches the packet identifier in the third packet, determine that the third packet is a reply packet returned by the second server based on the jumbo frame identifier in the first jumbo frame packet.

If the second server needs to return a reply packet, the second server generates the reply packet based on a probe identifier, and adds an ACK (Jumbo-Pong) to header information of the reply packet.

In this embodiment of the present disclosure, the probe jumbo frame identifier is transmitted in a plurality of probe time periods. Therefore, it needs to be determined that a received packet is a reply packet corresponding to a specific probe time period. Therefore, when the third packet returned by the second server is received in the current probe time period, the packet identifier in the third packet is extracted, and is matched with the transmitting packet identifiers in the plurality of first jumbo frame packets in the configuration table. If the currently extracted packet identifier in the third packet is 1002, and the transmitting packet identifier in the current probe time period is also 1002, it can be determined that the third packet is a reply packet corresponding to the current probe time period.

However, if no corresponding reply packet is received in the probe time period in which the transmitting packet identifier is 1001, and third packets whose identifiers are respectively 1001 and 1002 are consecutively received in the probe time period corresponding to the transmitting packet identifier of 1002, matching is separately performed, and reply packets in the two probe time periods are separately determined.

Operation 904: Determine, based on a preset first threshold, whether a reply packet is received.

The first server records transmitting time (last-tx-jumbo-ping-ts) of each first jumbo frame packet. When entering a next probe time period, the first server records transmitting time of a first jumbo frame packet in a current probe time period, sets the first threshold to 1 s, and determines whether a corresponding reply packet can be received within 1 s after last-tx-jumbo-ping-ts.

Operation 905: When a corresponding reply packet is received, record receiving time of the reply packet, and determine first duration between transmitting time and the receiving time; and when the first duration is greater than the first threshold, or when no matched reply packet is received in the current probe time period, determine that the first transmission tunnel is not suitable for jumbo frame transmission in the current probe time period.

When the first server receives the corresponding reply packet, the first server also records receiving time (last-rx-jumbo-ping-ts) of receiving the packet. If the corresponding reply packet is received only after Is starting from last-tx-jumbo-ping-ts, it is considered that a delay is excessively high, and it is determined that the first transmission tunnel is not suitable for jumbo frame transmission in the current probe time period.

Alternatively, when no corresponding reply packet is received in the current probe time period, it may also be determined that the first transmission tunnel is not suitable for jumbo frame transmission in the current period.

In addition, if a delay requirement is relatively low, in this embodiment, error determining may also be performed, and reply time in the reply packet may be extracted. The reply time is recorded when the second server transmits the reply packet. Second duration between the transmitting time and the reply time and third duration between the receiving time and the reply time are determined. Only when a difference between the second duration and the third duration is greater than a preset second threshold, a probe result indicating that the first transmission tunnel is not suitable for jumbo frame transmission is obtained. Otherwise, when a difference between the second duration and the third duration does not exceed a preset second threshold, a probe result indicating that the first transmission tunnel is suitable for jumbo frame transmission is determined.

In some embodiments, if a delay requirement is relatively low, after a probe result indicating that the first transmission tunnel is not suitable for jumbo frame transmission is obtained because no reply packet is received, when a reply packet returned in this case is received in a subsequent period (for example, three consecutive periods) and a difference between second duration and third duration corresponding to each reply packet is greater than the preset second threshold, the probe result may be adjusted. It is considered that the first transmission tunnel between the first server and the second server can transmit a jumbo frame packet, but a delay is excessively high.

Operation 906: Determine an accumulated quantity of probe results indicating that the first transmission tunnel is not suitable for jumbo frame transmission; and continue to transmit the first jumbo frame packet to the second server through the first transmission tunnel in a next probe time period when the accumulated quantity is less than a preset third threshold; or decrease the transmission limit value of the first transmission tunnel when the accumulated quantity reaches a third threshold.

Using an example in which the third threshold is 3, when the accumulated quantity (jumbo-ping-failure) does not reach 3, the first jumbo frame packet may continue to be transmitted to the second server through the first transmission tunnel in a next probe time period. When jumbo-ping-failure is equal to 3, it is considered that a result indicating that the first transmission tunnel is suitable for jumbo frame transmission cannot be obtained in a plurality of consecutive probe time periods.

Operation 907: When a probe result indicating that the first transmission tunnel is not suitable for jumbo frame transmission is obtained, adjust the transmission limit value of the first transmission tunnel to a first value; or when a probe result indicating that the first transmission tunnel is suitable for jumbo frame transmission is obtained, obtain a to-be-transmitted second jumbo frame packet, and transmit the second jumbo frame packet to the second server through the first transmission tunnel.

If it is learned in three consecutive probe time periods that the first transmission tunnel is not suitable for jumbo frame transmission, the transmission limit value of the first transmission tunnel may be decreased. Herein, it is learned in three consecutive probe time periods that the first transmission tunnel is not suitable for jumbo frame transmission, indicating that an MTU value in previous tunnel_jumbo_conifg is excessively large and needs to be adjusted. Using an example in which the first value is 1500 bytes, a jumbo frame tunnel is a tunnel capable of transmitting a packet with a length greater than 1500 bytes. In this case, the MTU value of the first transmission tunnel may be directly decreased to 1500 bytes.

On the contrary, if a probe result indicating that the first transmission tunnel is suitable for jumbo frame transmission can be obtained in any probe time period, subsequently, the first server may normally forward the second jumbo frame packet to the second server through the first transmission tunnel.

The foregoing tunnel_jumbo_conifg not only records a transmitting status of each first jumbo frame packet, but also records tunnel_jumbo_conifg of a plurality of different transmission tunnels, corresponding timestamps, and the like. As shown in Table 1, Table 1 shows tunnel_jumbo_conifg according to an embodiment of the present disclosure.

TABLE 1
Configuration table

| | | | | | Packet | | | | |
|---|---|---|---|---|---|---|---|---|---|
| | | | | | length | | | | |
| | | | | | value of | | | | |
| | | Virtual | Virtual | | the first | | | | |
| First | Second | bridge IP | bridge IP | | jumbo | Transmitting | | | |
| server | server | address | address | Transmission | frame | packet | Transmitting | Receiving | Accumulated |
| identifier | identifier | source | destination | limit value | packet | identifier | time | time | quantity |
| 1.1.1.1 | 2.2.2.1 | 1.1.1.2 | 2.2.2.2 | 9100 | 3100 | 1001 | 1676987794 | 1676987795 | 2 |
| 1.1.1.1 | 2.2.2.1 | 1.1.1.2 | 2.2.2.3 | 1500 | 3100 | 1002 | 1676987750 | . . . | 0 |

In Table 1, the first server identifier (cluster-src) indicates a source cluster of a packet. The receiving packet identifier (cluster-dst) indicates a destination cluster of a packet. The virtual bridge IP address source (vbip-src) indicates a source virtual bridge IP address of a packet. The virtual bridge IP address destination (vbip-dst) indicates a destination virtual bridge IP address of a packet. Both vbip-src and vbip-dst correspond to the first transmission tunnel. The transmission limit value indicates a currently recorded maximum transmission unit of the first transmission tunnel. The packet length value (jumbo-xmited) of the first jumbo frame packet is a length of the transmitted first jumbo frame packet, and these data packets are usually greater than a standard MTU value. The transmitting packet identifier (last-jumbo-ping-id) is an identifier of a previously transmitted first jumbo frame packet, and is configured for uniquely identifying a jumbo frame Ping request. The transmitting time (last-tx-jumbo-ping-ts) is transmitting time of a previous first jumbo frame packet. The receiving time (last-rx-jumbo-pong-ts) is receiving time of a previous reply packet. The accumulated quantity (jumbo-ping failure) indicates an accumulated quantity of probe results indicating that the first transmission tunnel is not suitable for jumbo frame transmission.

In addition, when the accumulated quantity reaches the third threshold, the packet length value of the first jumbo frame packet may be further extracted, the second value is obtained based on the packet length value of the first jumbo frame packet, and the transmission limit value of the first transmission tunnel is decreased to the second value. The second value is less than the packet length value of the first jumbo frame packet and greater than the first value. For example, it is assumed that the transmission limit value of the first transmission tunnel is limited to 5000 bytes at the beginning, which indicates that a jumbo frame packet with a length of a maximum of 5000 bytes can be transmitted. However, during actual probe, after the first jumbo frame packet of 5000 bytes is transmitted, a probe result indicating that the first transmission tunnel is not suitable for jumbo frame transmission is obtained, which indicates that the tunnel actually does not support forwarding of a packet with a length of 5000 bytes. However, the tunnel may further support forwarding of a jumbo frame packet of another size. Subsequently, the transmission limit value of the first transmission tunnel is adjusted level by level. For example, the transmission limit value is adjusted to 4000 bytes, a first jumbo frame packet with a length of 4000 bytes is configured, and whether the first transmission tunnel supports a jumbo frame forwarding capability continues to be probed by using the packet. If a probe result indicating that the first transmission tunnel is suitable for jumbo frame transmission is obtained in this case, the second value, that is, 4000 bytes, may be used as a final transmission limit value of the first transmission tunnel. On the contrary, if a probe result indicating that the first transmission tunnel is not suitable for jumbo frame transmission is obtained, the transmission limit value of the first transmission tunnel may continue to be decreased until an appropriate value is found. In this way, a maximum packet length for transmission actually supported by the first transmission tunnel can be determined, so as to properly forward a jumbo frame packet and improve packet transmission efficiency.

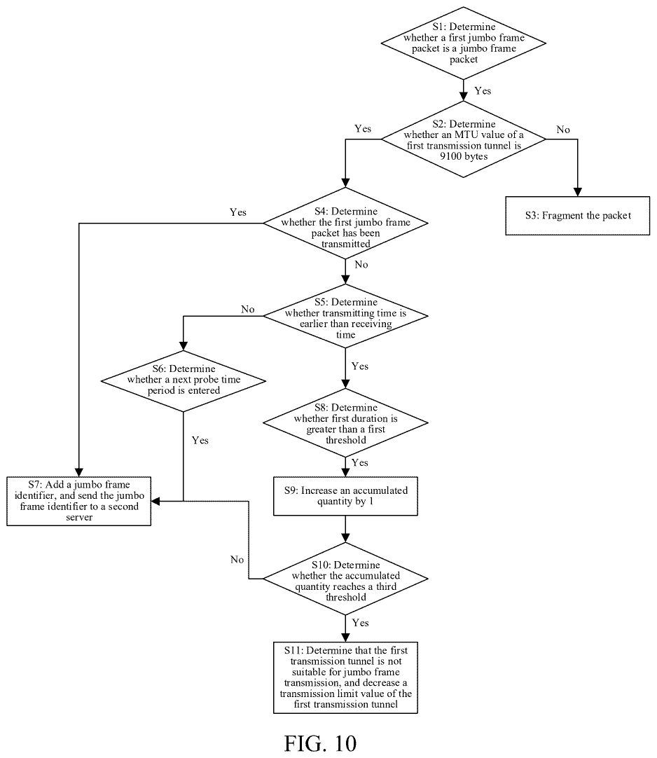

For better description of the embodiments of the present disclosure, with reference to the foregoing embodiment in FIG. 9, referring to FIG. 10 together, FIG. 10 is a schematic flowchart of a packet transmission method performed by a first server according to an embodiment of the present disclosure.

S1: Determine whether a first jumbo frame packet is a jumbo frame packet.

After receiving the first jumbo frame packet, the first server subsequently needs to probe a jumbo frame forwarding capability of a first transmission tunnel. If the first jumbo frame packet is a jumbo frame packet in S1, operation S2 is performed.

S2: Determine whether an MTU value of the first transmission tunnel is 9100 bytes.

The MTU value herein is a transmission limit value. Herein, determining whether the first transmission tunnel is suitable for transmitting a jumbo frame whose length is 9100 bytes is used as an example. When the MTU value is 9100 bytes, a jumbo frame transmission capability is probed, and operation S3 is performed; otherwise, probe does not need to be performed, and operation S4 is performed.

S3: Fragment the packet.

If the MTU value is not 9100 bytes, in this embodiment, probe is stopped, and it is recommended to perform other processing after fragmentation on the packet.

S4: Determine whether the first jumbo frame packet has been transmitted.

If the first server has not transmitted the first jumbo frame packet, last-tx-jumbo-ping-ts is 0, and operation S7 is performed; otherwise, it indicates that the first jumbo frame packet has been transmitted, a jumbo frame forwarding capability is determined subsequently, and operation S5 is performed.

S5: Determine whether transmitting time is earlier than receiving time.

If last-tx-jumbo-ping-ts is less than last-rx-jumbo-ping-ts, it indicates that a reply packet has been received in a current probe time period, and operation S8 is performed; otherwise, it is considered that no reply packet is received in a current probe time period, and operation S6 is performed.

After receiving the reply packet, the first server may further update tunnel_jumbo_conifg.

S6: Determine whether a next probe time period is entered.

The probe time period is 10 s. When 10 s expire after the transmitting time, the next probe time period is entered, the first transmission tunnel continues to be probed, and operation S7 is performed.

S7: Add a jumbo frame identifier, and transmit the jumbo frame identifier to a second server.

When the first jumbo frame packet needs to be forwarded, a jumbo frame identifier needs to be added to the packet, and then the packet is transmitted to the second server.

S8: Determine whether first duration is greater than a first threshold.

The first duration may be obtained by subtracting last-tx-jumbo-ping-ts from last-rx-jumbo-ping-ts, and the first threshold may be set to 1 s. If the first duration is greater than the first threshold, it is considered that the first transmission tunnel is temporarily not suitable for jumbo frame transmission, and operation S9 is performed; otherwise, it is determined that the first transmission tunnel is suitable for jumbo frame transmission.

S9: Increase an accumulated quantity by 1.

If it is considered that the first transmission tunnel is temporarily not suitable for jumbo frame transmission, the accumulated quantity is increased, and then operation S10 is performed.

S10: Determine whether the accumulated quantity reaches a third threshold.

The third threshold may be set to 3 times. If a quantity of failure times reaches 3, it is considered that the first transmission tunnel does not support jumbo frame forwarding, and operation S11 is performed; otherwise, operation S7 is performed.

S11: Determine that the first transmission tunnel is not suitable for jumbo frame transmission, and decrease the transmission limit value of the first transmission tunnel. For example, the MTU value is decreased to 1500 bytes.

If the quantity of failure times reaches 3, it is considered that the first transmission tunnel does not support jumbo frame forwarding. Subsequently, the MTU value may be adjusted to 1500 bytes, and only a non-jumbo-frame packet is transmitted through the tunnel subsequently.

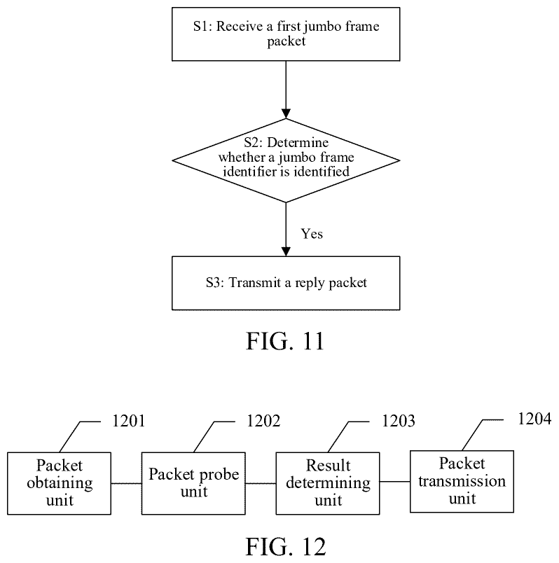

For better description of the embodiments of the present disclosure, with reference to the foregoing embodiment in FIG. 9, referring to FIG. 11 together, FIG. 11 is a schematic flowchart of a packet transmission method performed by a second server according to an embodiment of the present disclosure.

S1: Receive a first jumbo frame packet.

If a first transmission tunnel supports jumbo frame forwarding, the second server may receive the first jumbo frame packet through the first transmission tunnel, and then perform operation S2.

S2: Whether a jumbo frame identifier is identified.

The second server needs to extract header information of the first jumbo frame packet, and if the jumbo frame identifier can be extracted from the header information, determines that the received packet is a jumbo frame packet, and performs operation S3.

S3: Transmit a reply packet.

The reply packet is generated based on the jumbo frame identifier. After generating the reply packet, the second server may transmit the reply packet to a first server through the first transmission tunnel.

To better implement the packet transmission method provided in the embodiments of the present disclosure, the embodiments of the present disclosure further provide an apparatus based on the foregoing packet transmission method. Nouns have meanings the same as those in the foregoing packet transmission method. For specific implementation details, refer to the descriptions in the method embodiments.

Referring to FIG. 12, FIG. 12 is a schematic structural diagram of a packet transmission apparatus according to an embodiment of the present disclosure. The packet transmission apparatus is used in a first server. The packet transmission apparatus may include a packet obtaining unit 1201, a packet probe unit 1202, a result determining unit 1203, a packet transmission unit 1204, and the like.

The packet obtaining unit 1201 is configured to obtain a first jumbo frame packet, the first jumbo frame packet carrying a jumbo frame identifier.

The packet probe unit 1202 is configured to transmit the first jumbo frame packet to a second server through a first transmission tunnel, the first transmission tunnel being one of at least one transmission tunnel for communicating with the second server.

The result determining unit 1203 is configured to determine a probe result for the first transmission tunnel based on a time relationship between transmitting time of the first jumbo frame packet and receiving time of a reply packet when receiving the reply packet returned by the second server based on the jumbo frame identifier in the first jumbo frame packet.

The packet transmission unit 1204 is configured to obtain a second jumbo frame packet and transmit the second jumbo frame packet to the second server through the first transmission tunnel when the probe result indicates that the first transmission tunnel is suitable for jumbo frame transmission.

To better implement the packet transmission method provided in the embodiments of the present disclosure, the embodiments of the present disclosure further provide an apparatus based on the foregoing packet transmission method. Nouns have meanings the same as those in the foregoing packet transmission method. For specific implementation details, refer to the descriptions in the method embodiments. For example, for a more specific implementation of the foregoing packet transmission apparatus, refer to the embodiments in FIG. 3, FIG. 9, and FIG. 11. Details are not described herein again.

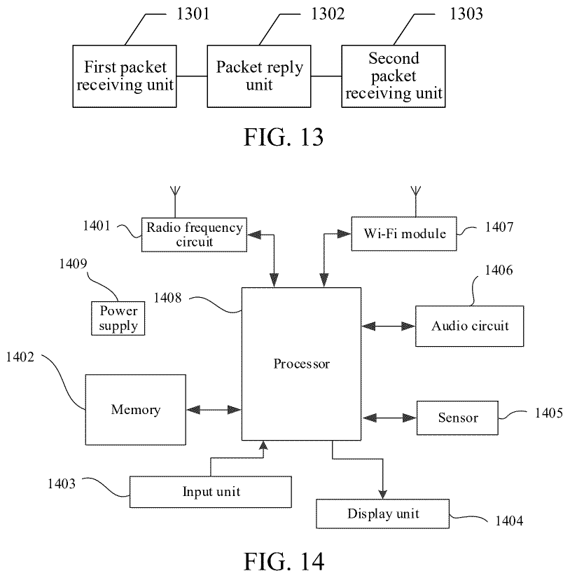

Referring to FIG. 13, FIG. 13 is a schematic structural diagram of a packet transmission apparatus according to an embodiment of the present disclosure. The packet transmission apparatus is used in a second server. The packet transmission apparatus may include a first packet receiving unit 1301, a packet reply unit 1302, a second packet receiving unit 1303, and the like.

The first packet receiving unit 1301 is configured to receive, through a first transmission tunnel, a first jumbo frame packet transmitted by a first server, the first jumbo frame packet carrying a jumbo frame identifier, and the first transmission tunnel being one of at least one transmission tunnel for communicating with the first server.

The packet reply unit 1302 is configured to generate a reply packet based on the jumbo frame identifier in the first jumbo frame packet; and transmit the reply packet to the first server through the first transmission tunnel, so that the first server determines a probe result for the first transmission tunnel based on a time relationship between transmitting time of the first jumbo frame packet and receiving time of the reply packet.

The second packet receiving unit 1303 is configured to receive, through the first transmission tunnel, a second jumbo frame packet transmitted by the first server, the second jumbo frame packet being transmitted by the first server when the probe result indicates that the first transmission tunnel is suitable for jumbo frame transmission.

For specific implementations of the foregoing units, reference may be made to the foregoing embodiments. Details are not described herein again.

An embodiment of the present disclosure further provides a computer device. The computer device may be a terminal. FIG. 14 is a schematic structural diagram of a terminal according to an embodiment of the present disclosure. Specifically:

The computer device may include components such as a radio frequency (RF) circuit 1401, a memory 1402 including one or more computer-readable storage media, an input unit 1403, a display unit 1404, a sensor 1405, an audio circuit 1406, a wireless fidelity (Wi-Fi) module 1407, a processor 1408 including one or more processing cores, and a power supply 1409. A person skilled in the art may understand that a structure of the terminal shown in FIG. 14 constitutes no limitation to the terminal, and the terminal may include more or fewer components than those shown in the figure, or some components may be combined, or a different component deployment may be used. In the terminal:

The RF circuit 1401 may be configured to receive and transmit signals in an information transmitting/receiving process or a call process. In particular, after receiving downlink information from a base station, the RF circuit delivers the downlink information to one or more processors 1408 for processing. In addition, the RF circuit transmits related uplink data to the base station. Generally, the RF circuit 1401 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 1401 may also communicate with a network and another device by wireless communication. The wireless communication may use any communication standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), email, Short Messaging Service (SMS), and the like.

The memory 1402 may be configured to store a software program and module. The processor 1408 runs the software program and module stored in the memory 1402, to perform various functional applications and information retrieval. The memory 1402 may mainly include a program storage area and a data storage area. The program storage area may store an operating system, an application program required by at least one function (for example, a sound play function and an image display function), and the like. The data storage area may store data (for example, audio data and an address book) created according to use of the terminal, and the like. In addition, the memory 1402 may include a high-speed random access memory, and may further include a non-volatile memory, such as at least one magnetic disk storage device, a flash storage device, or another volatile solid-state storage device. Correspondingly, the memory 1402 may further include a memory controller, to allow the processor 1408 and the input unit 1403 to access the memory 1402.

The input unit 1403 may be configured to receive entered digit or character information and generate keyboard, mouse, joystick, optical, or trackball signal input related to subscriber settings and function control. Specifically, in a specific embodiment, the input unit 1403 may include a touch-sensitive surface and another input device. The touch-sensitive surface, which may also be referred to as a touchscreen or a touchpad, may collect a touch operation of a subscriber on or near the touch-sensitive surface (such as an operation performed by the subscriber on or near the touch-sensitive surface by using any suitable object or accessory such as a finger or a stylus), and drive a corresponding connection apparatus according to a preset program. In some embodiments, the touch-sensitive surface may include two parts: a touch detection apparatus and a touch controller. The touch detection apparatus detects a touch orientation of the subscriber, detects a signal generated by the touch operation, and transmits the signal to the touch controller. The touch controller receives touch information from the touch detection apparatus, converts the touch information into touch point coordinates, and transmits the touch point coordinates to the processor 1408. Moreover, the touch controller can receive and execute a command transmitted from the processor 1408. In addition, the touch-sensitive surface may be implemented in a plurality of types, such as a resistive type, a capacitive type, an infrared type, and a surface acoustic wave type. In addition to the touch-sensitive surface, the input unit 1403 may further include the another input device. Specifically, the another input device may include, but is not limited to, one or more of a physical keyboard, a functional button (for example, a volume control button or an on/off button), a trackball, a mouse, a joystick, and the like.

The display unit 1404 may be configured to display information entered by the subscriber or information provided for the subscriber and various graphical subscriber interfaces of the terminal. These graphical subscriber interfaces may include a graphic, a text, an icon, a video, and any combination thereof. The display unit 1404 may include a display panel. In some embodiments, the display panel may be configured in the form of a liquid crystal display (LCD), an organic light-emitting diode (OLED), or the like. Further, the touch-sensitive surface may cover the display panel. After detecting a touch operation on or near the touch-sensitive surface, the touch-sensitive surface transmits the touch operation to the processor 1408 to determine a type of a touch event. Then, the processor 1408 provides a corresponding visual output on the display panel according to the type of the touch event. Although the touch-sensitive surface and the display panel are used as two independent components to implement input and output functions in FIG. 14, in some embodiments, the touch-sensitive surface and the display panel may be integrated to implement the input and output functions.

The terminal may further include at least one sensor 1405, such as an optical sensor, a motion sensor, and another sensor. Specifically, the optical sensor may include an ambient light sensor and a proximity sensor. The ambient light sensor may adjust brightness of the display panel based on brightness of ambient light, and the proximity sensor may turn off the display panel and/or backlight when the terminal approaches an ear. As one type of motion sensor, a gravity acceleration sensor can detect magnitude of accelerations in various directions (generally on three axes), can detect magnitude and a direction of the gravity when being static, and can be applied to an application that recognizes the attitude of the mobile phone (for example, switching between landscape mode and portrait mode, a related game, and magnetometer attitude calibration), a function related to vibration recognition (such as a pedometer and a knock), and the like. Other sensors such as a gyroscope, a barometer, a hygrometer, a thermometer, and an infrared sensor that may be configured on the terminal are not further described herein.

The audio circuit 1406, a speaker, and a microphone may provide an audio interface between the subscriber and the terminal. The audio circuit 1406 may convert received audio data into an electrical signal and transmit the electrical signal to the speaker. The speaker converts the electrical signal into a sound signal for output. In another aspect, the microphone converts a collected sound signal into an electrical signal. The audio circuit 1406 receives the electrical signal, converts the electrical signal into audio data, and outputs the audio data to the processor 1408 for processing. Then, the audio data is transmitted to, for example, another terminal through the RF circuit 1401, or is outputted to the memory 1402 for further processing. The audio circuit 1406 may further include an earplug jack, to provide communication between a peripheral headset and the terminal.

Wi-Fi is a short-range wireless transmission technology. The terminal may help, by using the Wi-Fi module 1407, the subscriber transmit and receive emails, browse a web page, access streaming media, and the like, to allow wireless broadband Internet access of the subscriber. Although FIG. 14 shows the Wi-Fi module 1407, the Wi-Fi module is not a mandatory component of the terminal, and may be omitted as required without changing the essence of the present disclosure.

The processor 1408 is a control center of the terminal, is connected to each part of the entire terminal by using various interfaces and lines, and performs various functions of the terminal and processes data by running or executing the software program and/or module stored in the memory 1402 and invoking data stored in the memory 1402, to perform overall monitoring on the terminal. In some embodiments, the processor 1408 may include one or more processing cores. Preferably, an application processor and a modem processor may be integrated into the processor 1408. The application processor mainly processes an operating system, a subscriber interface, an application program, and the like. The modem processor mainly processes wireless communication. The modem processor may alternatively not be integrated into the processor 1408.

The terminal further includes the power supply 1409 (such as a battery) for supplying power to the components. Preferably, the power supply may be logically connected to the processor 1408 by using a power management system, thereby implementing functions such as charging management, discharging management, and power consumption management by using the power management system. The power supply 1409 may further include one or more of a direct current or alternating current power supply, a rechargeable system, a power failure detection circuit, a power supply converter or inverter, a power supply state indicator, and any other components.

Although not shown, the terminal may further include a camera, a Bluetooth module, and the like, which are not described in detail herein. Specifically, in this embodiment, the processor 1408 in the terminal loads executable files corresponding to processes of one or more application programs to the memory 1402 according to the following instructions, and the processor 1408 runs the application programs stored in the memory 1402, to implement the packet transmission method in the embodiments of the present disclosure.

In the foregoing embodiments, the descriptions of the embodiments have different focuses, and for a part that is not described in detail in an embodiment, reference may be made to the detailed description of the packet transmission method above. Details are not described herein again.

It can be learned from the foregoing descriptions that the computer device in the embodiments of the present disclosure may determine at least one receiving device for transmission from a connected local area network, where each receiving device includes an Internet Protocol address allocated in the local area network, and each receiving device enables a preset transport protocol server based on the corresponding Internet Protocol address; determine at least one to-be-transmitted transfer file; and transmit, based on a preset transport protocol corresponding to the preset transport protocol server, the at least one transfer file to the preset transport protocol server corresponding to each receiving device. In this way, the preset transport protocol server is pre-created by using each receiving device in the local area network, to open a fast transmission tunnel of the preset transport protocol, so that the at least one transfer file is quickly transmitted to the preset transport protocol server corresponding to each receiving device based on the preset transport protocol. Compared with a solution of transmission through Bluetooth or an instant messaging application program in a related technology, the embodiments of the present disclosure do not rely on limitations of the Internet and a hardware module, and support inter-system transmission and parallel transmission with a plurality of receiving devices, thereby greatly improving efficiency and universality of packet transmission.

A person of ordinary skill in the art may understand that, all or some operations of the methods in the foregoing embodiments may be implemented by using instructions, or implemented by controlling relevant hardware by using instructions, and the instructions may be stored in a computer-readable storage medium and loaded and executed by a processor.

Accordingly, an embodiment of the present disclosure provides a computer-readable storage medium, having a plurality of instructions stored therein. The instructions can be loaded by a processor, to perform the operations in any packet transmission method provided in the embodiments of the present disclosure.

According to an aspect of the present disclosure, a computer program product or a computer program is provided, the computer program product or the computer program includes computer instructions, and the computer instructions are stored in a computer-readable storage medium. A processor of a computer device reads the computer instructions from the computer-readable storage medium, and executes the computer instructions, so that the computer device performs the method provided in various exemplary implementations provided in the foregoing embodiments.

For specific implementations of the foregoing operations, reference may be made to the foregoing embodiments. Details are not described herein again.

The computer-readable storage medium may include: a read-only memory (ROM), a random access memory (RAM), a magnetic disk, an optical disc, or the like.

Since the instructions stored in the computer-readable storage medium can perform the operations in any packet transmission method provided in the embodiments of the present disclosure, advantageous effects that can be achieved by any packet transmission method provided in the embodiments of the present disclosure can be achieved. The foregoing embodiments may be referred to for details. Details are not described herein again.

The packet transmission method and apparatus, the storage medium, the device, and the system provided in the embodiments of the present disclosure are described above in detail. Although the principles and implementations of the present disclosure are described by using specific examples in this specification, the foregoing descriptions of the embodiments are merely intended to help understand the method and core idea of the present disclosure. Moreover, a person skilled in the art may make modifications to the specific implementations and application scope according to the idea of the present disclosure. In conclusion, the content of the specification is not to be construed as a limitation to the present disclosure.

What is claimed is:

1. A packet transmission method performed by a first server, comprising:
obtaining a first jumbo frame packet, the first jumbo frame packet carrying a jumbo frame identifier;
transmitting the first jumbo frame packet to a second server through a first transmission tunnel, the first transmission tunnel being one of at least one transmission tunnel for communicating with the second server;
determining, when receiving a reply packet returned by the second server based on a jumbo frame identifier in the first jumbo frame packet, a probe result for the first transmission tunnel based on a time relationship between a transmitting time of the first jumbo frame packet and a receiving time of the reply packet; and
obtaining, when the probe result indicates that the first transmission tunnel is suitable for jumbo frame transmission, a second jumbo frame packet and transmitting the second jumbo frame packet to the second server through the first transmission tunnel.

2. The packet transmission method according to claim 1, wherein determining, when receiving the reply packet returned by the second server based on the jumbo frame identifier in the first jumbo frame packet, the probe result for the first transmission tunnel based on the time relationship between the transmitting time of the first jumbo frame packet and the receiving time of the reply packet comprises:
receiving a third packet from the second server; and
determining the probe result for the first transmission tunnel based on the time relationship between the transmitting time of the first jumbo frame packet and the receiving time of the reply packet when determining that the third packet is the reply packet returned by the second server based on the jumbo frame identifier in the first jumbo frame packet.

3. The packet transmission method according to claim 1, wherein determining the probe result for the first transmission tunnel based on the time relationship between the transmitting time of the first jumbo frame packet and the receiving time of the reply packet comprises:
determining a difference between the transmitting time of the first jumbo frame packet and the receiving time of the reply packet as first duration; and
determining, when the first duration is less than or equal to a preset first threshold, the probe result indicating that the first transmission tunnel is suitable for jumbo frame transmission.

4. The packet transmission method according to claim 3, wherein determining the probe result for the first transmission tunnel based on the time relationship between the transmitting time of the first jumbo frame packet and the receiving time of the reply packet comprises:
determining, when the first duration is greater than the preset first threshold, the probe result indicating that the first transmission tunnel is not suitable for jumbo frame transmission; or
extracting, when the first duration is greater than the preset first threshold, a reply time in the reply packet, the reply time indicating a time point when the second server transmits the reply packet;
determining a second duration between the transmitting time and the reply time and a third duration between the receiving time and the reply time; and
determining, when a difference between the second duration and the third duration is greater than a preset second threshold, the probe result indicating that the first transmission tunnel is not suitable for jumbo frame transmission.

5. The packet transmission method according to claim 1, wherein transmitting the first jumbo frame packet to the second server through the first transmission tunnel comprises:
successively transmitting the first jumbo frame packet to the second server through the first transmission tunnel in each of a plurality of probe time periods, two adjacent probe time periods being separated by a preset time interval.

6. The packet transmission method according to claim 5, wherein the method further comprises:
determining, when no reply packet returned by the second server based on the jumbo frame identifier in the first jumbo frame packet is received in a current probe time period, the probe result indicating that the first transmission tunnel is not suitable for jumbo frame transmission.

7. The packet transmission method according to claim 5, wherein the method further comprises:
determining, when the probe result indicating that the first transmission tunnel is not suitable for jumbo frame transmission is determined in a current probe time period, an accumulated quantity of probe results indicating that the first transmission tunnel is not suitable for jumbo frame transmission;
continuing to transmit the first jumbo frame packet to the second server through the first transmission tunnel in a next probe time period when the accumulated quantity is less than a preset third threshold; and
decreasing, when the accumulated quantity reaches the preset third threshold, a transmission limit value of the first transmission tunnel.

8. The packet transmission method according to claim 1, wherein obtaining the first jumbo frame packet comprises:
obtaining an initial jumbo frame packet;
extracting header information of the initial jumbo frame packet;
generating a jumbo frame identifier for the initial jumbo frame packet; and
adding the jumbo frame identifier to the header information of the initial jumbo frame packet to obtain the first jumbo frame packet.

9. The packet transmission method according to claim 8, wherein obtaining the first jumbo frame packet further comprises:
determining a packet length value of the initial jumbo frame packet;
obtaining a transmission limit value of the first transmission tunnel from a preset configuration table, the preset configuration table comprising transmission limit values of a plurality of transmission tunnels; and
fragmenting, when the packet length value of an initial jumbo frame packet is greater than the transmission limit value of the first transmission tunnel, the initial jumbo frame packet based on the transmission limit value to obtain an initial jumbo frame, wherein a packet length value of the initial jumbo frame does not exceed the transmission limit value.

10. The packet transmission method according to claim 9, wherein the method further comprises:
setting, when the probe result indicates that the first transmission tunnel is not suitable for jumbo frame transmission, the transmission limit value of the first transmission tunnel to a first value; or
extracting a packet length value of the first jumbo frame packet, obtaining a second value based on the packet length value of the first jumbo frame packet, and setting the transmission limit value of the first transmission tunnel to the second value, the second value being less than the packet length value of the first jumbo frame packet and greater than the first value.

11. A packet transmission method performed by a second server, comprising:
receiving, through a first transmission tunnel, a first jumbo frame packet transmitted by a first server, the first jumbo frame packet carrying a jumbo frame identifier, the first transmission tunnel being one of at least one transmission tunnel for communicating with the first server;
generating a reply packet based on the jumbo frame identifier in the first jumbo frame packet;
transmitting the reply packet to the first server through the first transmission tunnel, wherein the first server determines a probe result for the first transmission tunnel based on a time relationship between a transmitting time of the first jumbo frame packet and a receiving time of the reply packet; and
receiving, through the first transmission tunnel, a second jumbo frame packet transmitted by the first server, the second jumbo frame packet being transmitted by the first server when the probe result indicates that the first transmission tunnel is suitable for jumbo frame transmission.

12. The packet transmission method according to claim 11, wherein generating the reply packet based on the jumbo frame identifier in the first jumbo frame packet comprises:
extracting header information of the first jumbo frame packet;
extracting the jumbo frame identifier from the header information of the first jumbo frame packet; and
generating the reply packet based on the jumbo frame identifier.

13. The packet transmission method according to claim 11, wherein transmitting the reply packet to the first server through the first transmission tunnel comprises:
writing a reply time of the reply packet into the reply packet, and transmitting the reply packet to the first server through the first transmission tunnel, wherein the first server determines the probe result for the first transmission tunnel based on a time relationship between the transmitting time of the first jumbo frame packet, the receiving time of the reply packet, and the reply time of the reply packet into the reply packet.

14. A packet transmission apparatus, comprising a memory for storing instructions and a processor for executing the instructions, wherein the processor is configured to execute the instructions to:
obtain a first jumbo frame packet, the first jumbo frame packet carrying a jumbo frame identifier;
transmit the first jumbo frame packet to a second server through a first transmission tunnel, the first transmission tunnel being one of at least one transmission tunnel for communicating with the second server;
determine, when receiving a reply packet returned by the second server based on a jumbo frame identifier in the first jumbo frame packet, a probe result for the first transmission tunnel based on a time relationship between a transmitting time of the first jumbo frame packet and a receiving time of the reply packet; and
obtain, when the probe result indicates that the first transmission tunnel is suitable for jumbo frame transmission, a second jumbo frame packet and transmit the second jumbo frame packet to the second server through the first transmission tunnel.

15. The packet transmission apparatus of claim 14, wherein the processor, when being configured to determine, when receiving the reply packet returned by the second server based on the jumbo frame identifier in the first jumbo frame packet, the probe result for the first transmission tunnel based on the time relationship between the transmitting time of the first jumbo frame packet and the receiving time of the reply packet, is configured to execute the instructions to:
receive a third packet from the second server; and
determine the probe result for the first transmission tunnel based on the time relationship between the transmitting time of the first jumbo frame packet and the receiving time of the reply packet when determining that the third packet is the reply packet returned by the second server based on the jumbo frame identifier in the first jumbo frame packet.

16. The packet transmission apparatus of claim 14, wherein the processor, when being configured to determine the probe result for the first transmission tunnel based on the time relationship between the transmitting time of the first jumbo frame packet and the receiving time of the reply packet, is configured to execute the instructions to:
determine a difference between the transmitting time of the first jumbo frame packet and the receiving time of the reply packet as first duration; and
determine, when the first duration is less than or equal to a preset first threshold, the probe result indicating that the first transmission tunnel is suitable for jumbo frame transmission.

17. The packet transmission apparatus of claim 14, wherein the processor, when being configured to transmit the first jumbo frame packet to the second server through the first transmission tunnel, is further configured to execute the instructions to:
successively transmit the first jumbo frame packet to the second server through the first transmission tunnel in each of a plurality of probe time periods, two adjacent probe time periods being separated by a preset time interval.

18. A non-transitory computer readable medium storing a plurality of instructions, wherein the plurality of instructions, when executed by a processor, configure the processor to perform the operations in the method according to claim 1.

19. A packet transmission apparatus, comprising a memory for storing instructions and a processor for executing the instructions, wherein the processor is configured to execute the instructions to perform the operations in the method according to claim 11.

20. A non-transitory computer readable medium storing a plurality of instructions, wherein the plurality of instructions, when executed by a processor, configure the processor to perform the operations in the method according to claim 11.
